(19) United States
(12) Patent Application Publication
(10) Pub. No.: US 2011/0035247 A1
(43) Pub. Date: Feb. 10, 2011

(54) SYSTEMS, METHODS, APPARATUSES, AND COMPUTER PROGRAM PRODUCTS FOR DETERMINING PRODUCTIVITY ASSOCIATED WITH RETRIEVING ITEMS IN A WAREHOUSE

(75) Inventors: Andy L. Perry, Raleigh, NC (US); Jacqueline Hughes, Raleigh, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: United Parcel Service of America

(21) Appl. No.: 12/535,428

(22) Filed: Aug. 4, 2009

(51) Int. Cl. G06Q 10/00; G06Q 50/00

(52) U.S. Cl. 705/8

(57) ABSTRACT

An apparatus is provided for managing productivity associated with retrieval of items in real-time according to various embodiments. The apparatus includes a memory and a processor configured to generate a first time for traveling to one or more locations in which the items are located. The processor is also configured to generate a second time for retrieving the items from the locations and a third time for accessing one or more access points corresponding to each location. The third time is based on a respective height of each access point. The processor is also configured to add the first, second, and third times to generate a fourth time representing a target pick time for retrieving the items. Corresponding computer program products and methods are also provided.

### TECHNOLOGICAL FIELD

Embodiments of the invention relate generally to systems, methods, apparatuses, and computer program products for generating a target time in which one or more individuals are expected to retrieve items in a distribution center and generating data that is utilized by the distribution center (DC) to determine the efficiency of the one or more individuals.

### BACKGROUND

Many companies maintaining distribution centers or warehouses that control the movement and storage of materials do not track the productivity of employees such as pickers who are generally responsible for sorting, moving and retrieving items such as goods or products among locations in a distribution center or warehouse. Although some companies calculate and track a picker's productivity, the calculation and tracking is performed after the picker's work is completed. In particular, these companies utilize warehouse management system (WMS) applications and labor modules to track a picker's productivity after work is completed. However, these WMS applications and labor modules do not track the productivity of a picker's work on a real-time basis (e.g., while the picker is in the process of retrieving items). Thus, a need exists for improved productivity tracking systems.

### BRIEF SUMMARY

A system according to various embodiments determines a target pick time in which one or more individuals, such as pickers, are expected to pick or retrieve items that are ordered on behalf of an entity (e.g., a company). As referred to herein, a picker may be, for example, an individual who is responsible for sorting, retrieving and moving items (e.g., goods or products) among locations in a distribution center or warehouse. In various embodiments, the target pick time is determined on a real-time basis, for example, as soon as an order for the items is received or processed by the warehouse, and the system is configured to determine, in real-time, whether an individual retrieved the items from locations in a distribution center within the target pick time. This information may be used to assess the efficiency of the individual. This information may also be used to assess an individual's productivity and whether the individual is being utilized properly.

Various exemplary embodiments of the system are also configured to generate one or more reports summarizing the productivity of one or more individuals during a given time frame (e.g., a given day or week). The reports generated indicate whether individuals retrieved items within the targeted pick times, for example. In addition, the reports can be used by the personnel of a distribution center to determine ways in which to increase productivity, such as by reallocating resources.

In an exemplary embodiment, a computer program product for managing productivity associated with the retrieval of items is provided. The computer program product includes at least one computer-readable storage medium having computer-readable program code portions stored therein. The computer-readable program code portions may include a first executable portion configured to generate a first time for traveling to one or more locations at which one or more items to be retrieved are located, and a second executable portion configured to generate a second time for retrieving the items from the locations. The computer-readable program code portions may also include a third executable portion configured to generate a third time for accessing one or more access points corresponding to each location. The third time may be based on a respective height of each of the access points. The computer-readable program code portions may also include a fourth executable portion configured to add the first, second, and third times to generate a fourth time representing a target pick time for retrieving the items.

In another exemplary embodiment, an apparatus for managing productivity associated with the retrieval of items is provided. The apparatus may include a memory and a computer processor configured to generate a first time for traveling to one or more locations in which one or more items to be retrieved are located and may generate a second time for retrieving the items from the locations. The computer processor is also configured to generate a third time for accessing one or more access points corresponding to each location. The third time may be based on a respective height of each of the access points. The computer processor is also configured to add the first, second, and third times to generate a fourth time representing a target pick time for retrieving the one or more items.

In another exemplary embodiment, a method for managing productivity associated with the retrieval of items is provided. The method may include generating a first time for traveling to one or more locations in which one or more items are located and generating a second time for retrieving the items from the locations. The method may also include generating a third time for accessing one or more access points corresponding to each location. The third time may be based on a respective height of each of the access points. The method may also include adding, via a productivity computing device, the first, second and third times to generate a fourth time representing a target pick time for retrieving the items.

### BRIEF DESCRIPTION OF THE SEVERAL VIEWS OF THE DRAWINGS

Having thus described various embodiments of the invention in general terms, reference will now be made to the accompanying drawings, which are not necessarily drawn to scale, and wherein:

FIG. 1 is a schematic block diagram of warehouse picking productivity device according to an exemplary embodiment of the invention;

FIG. 2 is a schematic block diagram of an electronic device according to an exemplary embodiment of the invention;

FIG. 3 is a schematic diagram of a system according to an exemplary embodiment of the invention;

FIG. 4 is a schematic diagram of a distribution center or warehouse according to an exemplary embodiment of the invention;

FIG. 5 is a view of a table containing data corresponding to a base picking allowance associated with a picking operation according to an exemplary embodiment of the invention;

FIG. 6 is a view of a table containing data corresponding to a start order allowance associated with a picking operation according to an exemplary embodiment of the invention;

FIG. 7 is a view of a table containing data corresponding to a finish order allowance associated with a picking operation according to an exemplary embodiment of the invention;

FIG. 8 is a view of a table containing picking additive allowances corresponding to a picking operation according to an exemplary embodiment of the invention;

FIG. 9 is a view of a location allowance table associated with a picking operation according to an exemplary embodiment of the invention;

FIG. 10 is a view of a miscellaneous allowance table associated with a picking operation according to an exemplary embodiment of the invention;

FIG. 11 is a view of a stock-keeping unit (SKU) allowance table associated with a picking operation according to an exemplary embodiment of the invention;

FIG. 12 is a diagram of a pick ticket or order according to an exemplary embodiment of the invention;

FIG. 13 is a diagram of pick ticket allowance calculations according to an exemplary embodiment of the invention;

FIG. 14 illustrates a flowchart for determining employee productivity in real-time according to an exemplary embodiment of the invention;

FIG. 15 is a schematic diagram of a graphical user interface of a picking dashboard according to an exemplary embodiment of the invention;

FIG. 16 is a schematic diagram of a graphical user interface for managing one or more employees according to an exemplary embodiment of the invention;

FIG. 17 is a schematic diagram of an employee table according to an exemplary embodiment of the invention;

FIG. 18 is a schematic diagram of a graphical user interface according to an exemplary embodiment of the invention;

FIG. 19 is a schematic diagram of a pick trip table according to an exemplary embodiment of the invention;

FIG. 20 is a schematic diagram of a line item table according to an exemplary embodiment of the invention;

FIG. 21 is a schematic diagram of a graphical user interface for entering employee data according to an exemplary embodiment of the invention;

FIG. 22 illustrates work hours table according to an exemplary embodiment of the invention;

FIG. 23 illustrates an employee production summary according to an exemplary embodiment of the invention;

FIG. 24 illustrates an employee production detail report according to an exemplary embodiment of the invention;

FIG. 25 illustrates a daily production recap associated with one or more employees according to an exemplary embodiment of the invention; and

FIG. 26 illustrates a weekly production summary according to an exemplary embodiment of the invention.

### DETAILED DESCRIPTION

Various embodiments of the present invention now will be described more fully hereinafter with reference to the accompanying drawings, in which some, but not all embodiments of the inventions are shown. Indeed, these inventions are embodied in many different forms and should not be construed as limited to the embodiments set forth herein; rather, these embodiments are provided so that this disclosure will satisfy applicable legal requirements. Like numbers refer to like elements throughout.

### General Overview

In general, according to various embodiments, a target pick time is determined for an individual to pick (e.g., retrieve) one or more items that are ordered on behalf of an entity. The target pick time is determined on a real-time basis (e.g., prior to, simultaneously with, or shortly after an order for the items is received or processed by the DC or warehouse storing the items). In certain embodiments, the target pick time is the sum of various picking allowances, or time estimates, for performing discrete actions required to pick an item for shipment (e.g., estimates of time needed to read instructions to pick an item, travel to and retrieve each item, and handle each item). For example, at least a portion of the target pick time may be based on the number of items to be picked for an order, the location of the items within the warehouse or DC, the size and/or weight of the items, and/or specific handling instructions required for certain items or orders. In various embodiments, the target pick time is determined by a picking productivity module executed by a processor of a computing device. In addition, in various embodiments, the actual amount of time that the individual takes to pick the items is measured, and the picking productivity module compares the actual pick time with the target pick time to determine the efficiency of the individual.

According to various embodiments, the picking productivity module also generates a “pick ticket” that includes, for example, a listing of items to be picked, a location identification logic identifier for each item (which indicates the item's location within the warehouse), the quantity of each item, and the target pick time. In various embodiments, the pick ticket is then transmitted to a printer for printing a hard copy of the pick ticket, or in alternative embodiments, the pick ticket is transmitted to an electronic computing device that is adjacent or otherwise accessible to the individual assigned to the pick ticket and is displayed for the individual.

According to various embodiments, one or more reports summarizing the efficiency and/or productivity of the individual (or a group of individuals) during a given time frame are generated by the picking productivity module. As such, the efficiency and/or productivity of the individual retrieving items can be determined at-a-glance.

The picking productivity module, which is discussed in greater detail below, is stored in a memory of and executed by one or more computer processors of a warehouse picking productivity device, which is located at a distribution management center, according to various embodiments. However, in other various embodiments, the warehouse picking productivity device transmits the picking productivity module over a network to one or more electronic computing devices located at one or more distribution centers or warehouses from which items are to be picked and shipped, and the one or more computer processors of the electronic computing devices execute the picking productivity module. In yet another (or further) embodiment, the picking productivity module is stored on the electronic computing devices located at the one or more distribution centers or warehouses, and at least a portion of the data used by the picking productivity module is stored at the picking productivity module and is accessible to the electronic computing devices. These devices and the functionality of the system are described in greater detail below.

### Warehouse Picking Productivity Device

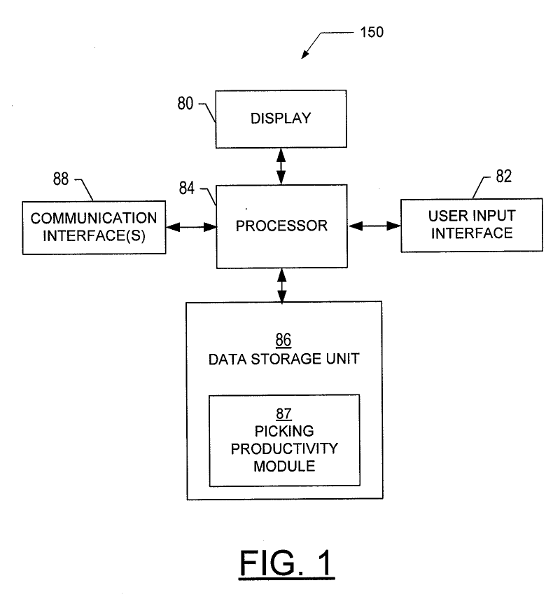

FIG. 1 illustrates a block diagram of a warehouse picking productivity device according to an exemplary embodiment of the invention. The warehouse picking productivity device 150 is a computing device that includes a processor 84 connected to a data storage unit 86. The data storage unit 86 comprises volatile and/or non-volatile memory and typically stores content, data, or the like. For example, the data storage unit 86 is configured to store content transmitted from, or received by, the warehouse picking productivity device 150. In various embodiments, the data includes data related to one or more picking allowances for picking operations, picking additives (e.g., additional allowances or adjustments based on the requirements of the particular pick process), information related to stock-keeping units (SKUs) of items to be picked, location of the items in a warehouse or distribution center (hereinafter collectively referred to as a warehouse), location and travel allowances based on the location of the items, employee information, productivity information related to one or more employees, information associated with one or more pick tickets, reports, and/or any other suitable information.

The data storage unit 86, in various embodiments, also stores one or more client applications, instructions, or the like, and the processor 84 executes one or more software modules of these applications or instructions. For instance, the data storage unit 86 stores a picking productivity module 87 that is executed by the processor 84. The picking productivity module 87, according to various embodiments, when executed by the processor 84, determines the productivity of one or more individuals (or “pickers”) responsible for sorting, moving, and retrieving items (e.g., goods or products) from various locations in the warehouse and generates one or more reports relating to the productivity of the pickers. In certain embodiments, the picking productivity module 87 when executed by the processor 84 also determines, in real-time, the picking utilization of one or more employees and the non-picking hours of employees. In addition, in a particular embodiment, the picking productivity module 87 when executed by the processor 84 also calculates a payment or fee that is owed to an entity (e.g., shipping carrier) for generating customized reports on behalf of the entity (e.g., a company).

In various embodiments, the warehouse picking productivity device 150 includes one or more logic elements for performing various functions as it executes one or more client application(s). The logic elements performing the functions are embodied in an integrated circuit assembly (e.g., an application specific integrated circuit (ASIC), field-programmable gate array (FPGA) or the like) including one or more integrated circuits integral or otherwise in communication with a respective network entity (e.g., computing system, client, server, etc.) or more particularly, for example, a processor of the respective network entity.

In addition to the data storage unit 86, the processor 84 is also connected to at least one interface or other device that displays, transmits, or receives data, content, or the like. The interface(s) includes at least one communication interface 88 or other means for transmitting and/or receiving data, content or the like. In this regard, the communication interface 88 includes, for example, an antenna and supporting hardware and/or software for enabling communications with a wireless communication network. For example, the communication interface(s) 88 includes a first communication interface for connecting to a first network, and a second communication interface for connecting to a second network. In addition, the warehouse picking productivity device 150 is configured to communicate with other electronic computing devices over a network such as a Local Area Network (LAN), Wide Area Network (WAN), Wireless Wide Area Network (WWAN), the Internet, or the like. Alternatively, the communication interface 88 supports a wired connection with the respective network. In addition to the communication interface(s) 88, the interfaces also include at least one user interface (e.g., one or more earphones or speakers), a display 80, and/or a user input interface 82. The user input interface 82, in turn, comprises any of a number of devices configured for receiving data from a user, such as, for example, a microphone, a keypad, keyboard, a touch display, a joystick, image capture device, pointing device (e.g., mouse), stylus or other input device.

### Electronic Computing Device

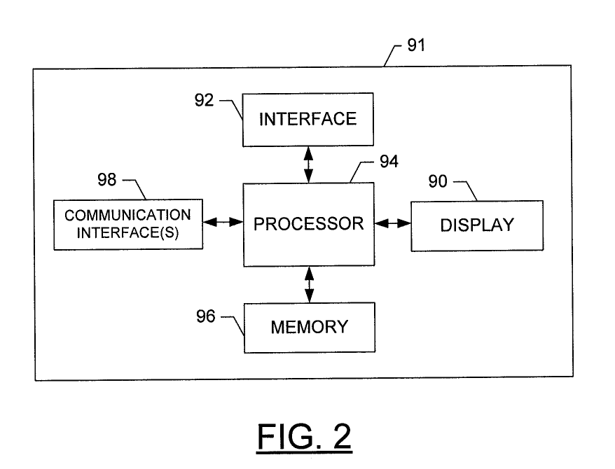

FIG. 2 illustrates a block diagram of an electronic computing device 91, such as a client, server, computing device (e.g., personal computer (PC), computer workstation, laptop computer, personal digital assistant (PDA), etc.). In various embodiments, the electronic computing device 91 is configured to communicate with the warehouse picking productivity device 150. As shown in FIG. 2, the electronic computing device 91 includes a processor 94 connected to a memory 96. The memory 96 comprises volatile and/or non-volatile memory, and typically stores content, data, or the like. For example, the memory 96 typically stores content transmitted from, and/or received by, the electronic computing device 91 and one or more client applications, instructions, or the like. For example, in various embodiments, the memory 96 stores data such as the data described above in relation to data storage unit 86. The processor 94 executes one or more software modules of these applications or instructions.

In addition to the memory 96, the processor 94 is also connected to at least one interface or other means for displaying, transmitting and/or receiving data, content, or the like. The interface(s) includes at least one communication interface 98 for transmitting and/or receiving data, content, or the like. For example, the communication interface(s) 98 includes an interface for connecting to a network (e.g., network 140). In various embodiments, the electronic computing device 91 is configured to communicate with the warehouse picking productivity device 150 over network 140 via the communication interface 98. The interface(s) also includes at least one user interface that includes a display 90 and/or a user input interface 92 that allows the electronic computing device 91 to receive data from a user, such as a keypad, keyboard, microphone, a touch display, or other input device.

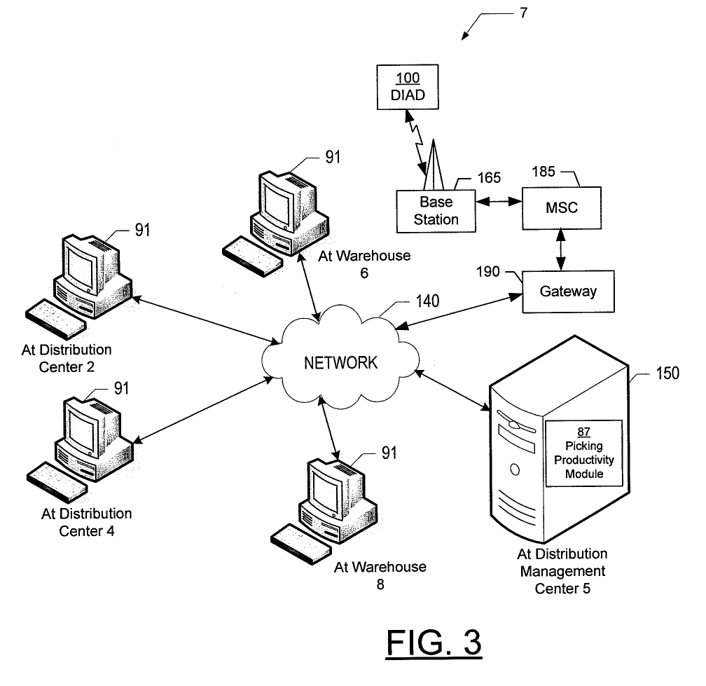

As discussed in more detail below in relation to FIG. 3, various embodiments of the invention include one or more electronic computing devices 91 in communication with the warehouse picking productivity device 150. For example, in one embodiment, the system includes a plurality of electronic computing devices 91 that include: (1) a first client computing device into which warehouse personnel receive orders and assign a particular picker to pick the items listed in the order; (2) a second client computing device into which operations personnel enter data related to various allowances and/or additives used to calculate the target pick time for each pick ticket, data related to the SKU numbers of items stocked, location of items within the warehouse (or plurality thereof), and/or employee information; and (3) a third client computing device that receives a particular pick ticket and provides the individual assigned to the pick ticket with access to the pick ticket (e.g., via a display or a printer that prints a copy of the print ticket). However, in various other embodiments, the functionality of the computing devices described above may be combined into one, two, or more than three computing devices in communication with the warehouse picking productivity device 150, and in yet another embodiment, at least a portion of the functionality described above may be performed by the warehouse picking productivity device 150.

### General System Architecture

Reference is now made to FIG. 3, which illustrates a block diagram of an overall warehouse picking productivity system 7 according to one embodiment of the invention. As shown in FIG. 3, electronic computing devices 91 are operated at entities such as distribution centers 2, 4 or warehouses 6, 8. Each of the electronic computing devices 91 are configured to communicate with the warehouse picking productivity device 150, or similar network entity, over a network 140, such as a wired or wireless local area network (LAN), a metropolitan network (MAN), and/or a wide area network (WAN) (e.g., the Internet). The warehouse picking productivity device 150 is maintained by a distribution management center 5 that is controlled and operated by a carrier (e.g., a shipping carrier). Although four electronic computing devices 91 are shown in FIG. 3, the warehouse picking productivity system in various other embodiments may include any suitable number of electronic computing devices. Additionally, although one warehouse picking productivity device 150 is shown in FIG. 3, various other embodiments of the system may include any other suitable number of warehouse picking productivity devices.

The system 7 according to the embodiment shown in FIG. 3 also includes a delivery information acquisition device (DIAD) 100 that includes an antenna (not shown) for transmitting signals to or receiving signals from a base station 165. The DIAD 100 is a mobile device that is movable throughout the system 7 and, thus, can be utilized at the distribution centers 2, 4, warehouses 6, 8, distribution center 5, or any other suitable entity within system 7. The base station 165 includes a cellular network, which includes elements required to operate the network, such as, for example, a mobile switching center (MSC) 185. The MSC 185 is configured to route information to and from the DIAD 100. The MSC 185 is coupled to a gateway 190, and the gateway 190 is coupled to a network 140 (e.g., Internet). As such, the electronic computing devices 91 as well as the warehouse picking productivity device 150 are configured to communicate with the DIAD 100 via the network 140.

The DIAD 100 includes a scanning device executed by a processor, controller or the like, and the scanning device is configured to scan one or more codes, labels (e.g., bar code labels), text, tracking numbers, or the like to obtain data. The data obtained by scanning is configured to be transmitted to the warehouse picking productivity device 150, which stores the data in its data storage unit 86 and uploads this information to a web site. For instance, in an exemplary embodiment, the DIAD 100 scans shipping labels or tracking numbers on retail products or goods, and the scanned data is provided by the DIAD 100 to warehouse picking productivity device 150, which uploads the data to a web site. Although only one DIAD 100, base station 165, MSC 185, and gateway 190 are shown in FIG. 3, the system 7 is configured to include any suitable number of DIADs 100, base stations 165, MSCs 185, and gateways 190.

In one exemplary embodiment, the distribution centers 2, 4, the warehouses 6, 8, the warehouse picking productivity device 150, the network 140, DIAD 100, base station 165, MSC 185, and gateway 190 are maintained and operated by a shipping carrier. However, in various alternative embodiments, one or more of these infrastructure elements may be maintained by more than one entity or institution (e.g., companies).

In one embodiment, the warehouse picking productivity device 150 of the distribution management center 5 is configured to transmit the picking productivity module 87 to the electronic computing devices 91 via the network 140, and the respective processors 94 of the electronic computing devices 91 are configured to execute the picking productivity module 87.

### Distribution Center/Warehouse

Items to be picked and packed for shipment according to an order received by the warehouse are stored in various locations within the warehouse, and the warehouse includes one or more stations at which particular activities in the pick and pack process occur. The items are typically stored on pallets, shelves, or racks within the warehouse, and each of these pallets, shelves, or racks are associated with an x, y coordinate corresponding to a particular location on the warehouse floor. Further, the one or more stations may include a base station at which a picker retrieves a pick ticket and begins the picking process, an equipment station from which equipment needed to access certain items are retrieved and stored, and a manifest station for packing and shipping the items retrieved. In various embodiments, any other suitable stations or areas associated with a warehouse may also be included.

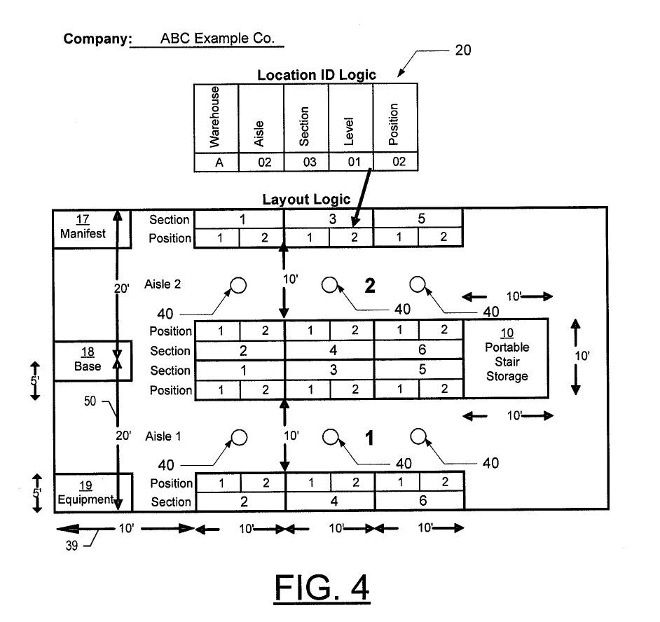

FIG. 4 illustrates a partial layout of a warehouse, such as DCs 2, 4 or warehouses 6, 8 shown in FIG. 2, according to an exemplary embodiment. The layout of the warehouse includes one or more aisles (e.g., Aisle 1, Aisle 2), a manifest station 17, a base station 18, an equipment station 19, a portable stair storage station 10, and various item sections on each aisle in which items are stored (e.g., Item Sections 1-6). The items may be stored on a particular level (e.g., Level 1 or Level 2) on a shelf located in a particular item section and at a particular position (e.g., Position 1, Position 2) within the section.

According to various embodiments, the specific location of a particular item disposed on a shelf within a warehouse is expressed using a location identification (ID) logic identifier that includes an indication of the warehouse, the aisle, the section, the level, and the position of the item. An exemplary embodiment of a location ID logic identifier 20 for a particular item is shown in FIG. 4 as A02030102, which indicates that the item is located in Warehouse A, on Aisle 02, in Section 03, on Level 01, and at Position 02. As described in more detail below, the location ID logic identifier associated with a particular item is parsed and utilized by the picker productivity module 87 to determine the travel allowance for each item, the location allowance for each item, and a picking route for retrieving multiple items listed in an order based on the location of the items within the warehouse and any special equipment needs associated with the items.

A. Distance between Locations in Warehouse

Each location on the floor of the warehouse is associated with a unique set of Cartesian coordinates (e.g., x-y coordinates), and the picking productivity module 87 determines the travel distance between various locations using these coordinates and certain equations and logic, which are described below in the section entitled “Pick Ticket Calculations.” In various embodiments, data indicating the coordinates of various sections or areas within a warehouse are stored in the data storage unit 86 of the warehouse picking productivity device 150. Alternatively, the electronic computing devices 91 at each respective warehouse stores the coordinates of each section or area within the warehouse.

B. Location Identification (ID) Logic Identifier

As noted above, the specific location of a particular item disposed on a shelf within a warehouse is expressed using a location ID logic identifier that includes an indication of the warehouse, the aisle, the section, the level, and the position of the item. In the exemplary embodiment shown in FIG. 4, the location ID logic identifier 20 shown at the top of the figure identifies an item located in Warehouse A, Aisle 02, Section 03, Level 01, and Position 02.

In various embodiments, the location ID logic identifier of each item is input via a user input interface 82 (e.g., a keyboard or the like) into the warehouse picking productivity device 150. For instance, in the exemplary embodiment of FIG. 4, each of the six item sections for each aisle in which items are stored includes one or more racks, and each rack is disposed in one of two positions within the item section (e.g., a right position and a left position). In particular, in the exemplary embodiment shown in FIG. 4, a rack located on Aisle 1 in Item Section 6 has two pallets disposed along Aisle 1, wherein the first pallet is located at Position 1 (toward the right of the section) and the second pallet is located at Position 2 (toward the left of the section). As described more fully below in the section titled “Pick Ticket Calculations”, the data associated with the location ID logic identifier for each item is accessed and utilized by the picking productivity module 87 to determine, in part, the target time for a picker to retrieve items identified in a pick ticket.

C. Pick Positions

FIG. 4 also illustrates one or more icons 40 denoting corresponding pick positions for each section of the DC or warehouse. The pick positions 40 are associated with unique x-y coordinates identifying their location within the warehouse, and the picking productivity module 87 utilizes the x-y coordinates of the pick positions to determine distances (and the corresponding travel time) for the picker to travel between these pick positions within the warehouse. This travel time is utilized, in part, to determine the target time for the picker to retrieve items identified in a pick ticket, as described more fully below in the section titled “Pick Ticket Calculations”.

D. Pick Routing Plan

The picking productivity module 87, according to various embodiments, is further configured to generate a pick routing plan that specifies the order in which a picker is to retrieve one or more items identified in a pick ticket. In various embodiments, the pick routing plan seeks to minimize the distance traveled by the picker within the warehouse to fulfill a particular pick ticket. In various embodiments, the pick routing plan assumes that the picker begins the picking process by retrieving the pick ticket at the base station, and then the picker proceeds to the equipment station to retrieve any equipment needed for picking the items on the pick ticket (e.g., a hand cart or a four-wheeled cart). From the equipment station, the picker travels to the item sections to retrieve the items listed on the pick ticket, and after the items have been retrieved, the picker takes the items to the manifest station for packing and shipping. Upon completion of the pick ticket, the picker inputs that the order is completed into a computing device (e.g., electronic computing device 91 or DIAD 100).

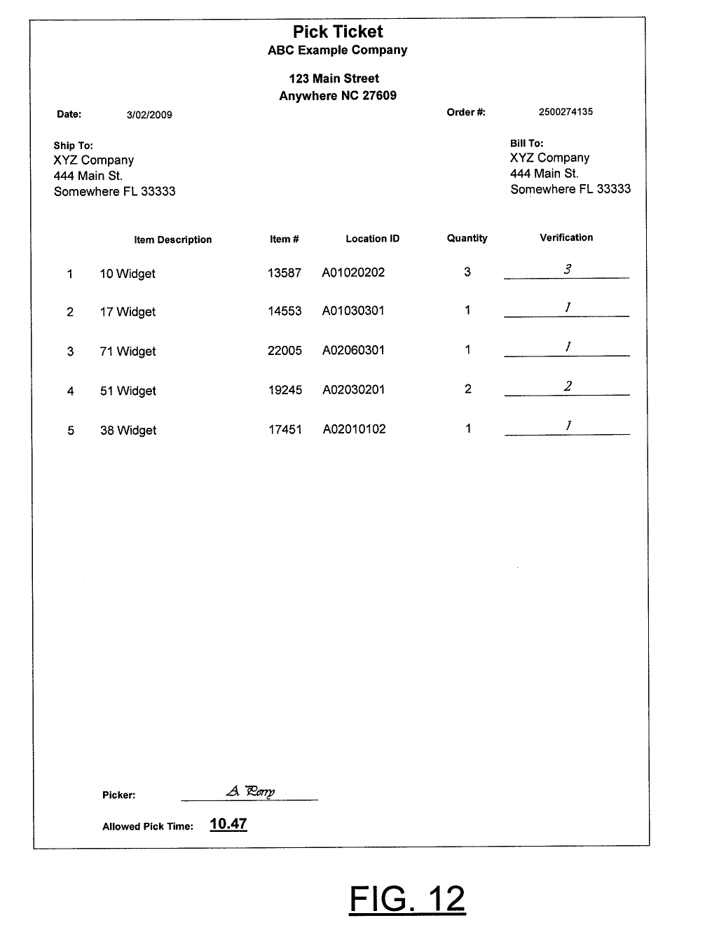

Based on the above assumptions, the picking productivity module 87 communicates a at least a portion of the pick routing plan to the picker by generating a pick ticket that lists the items to be retrieved in the order in which they are to be retrieved. For example, as shown in FIG. 12, the pick ticket indicates that the picker should first retrieve “10 Widget”, and then proceed to retrieve “17 Widget” second, “71 Widget” third, “51 Widget” fourth, and “38 Widget” last.

### Picking Allowances & Additives

According to various embodiments, data tables listing target times for performing one or more discrete actions required for picking one or more items identified in a pick ticket are utilized by the picking productivity module 87 to calculate the total target time expected for processing a particular pick ticket. In one embodiment, the data tables are stored in the data storage unit 86 of the warehouse picking productivity device 150, and in other embodiments, the data is stored in a data storage unit such as, for example, memory 96 of the electronic computing device 91 at the particular warehouse.

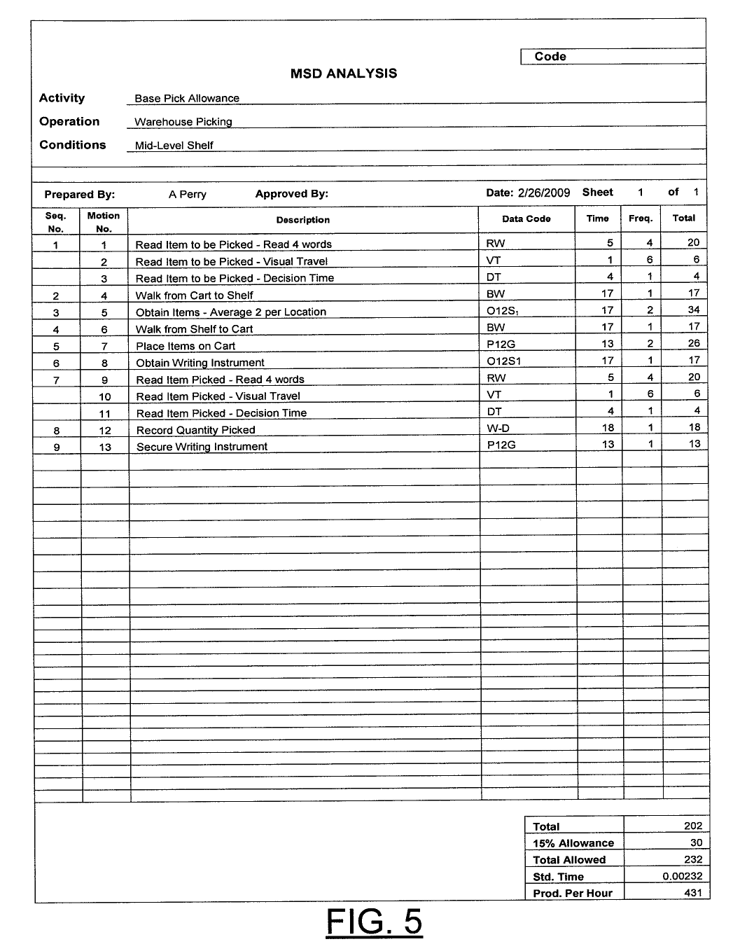

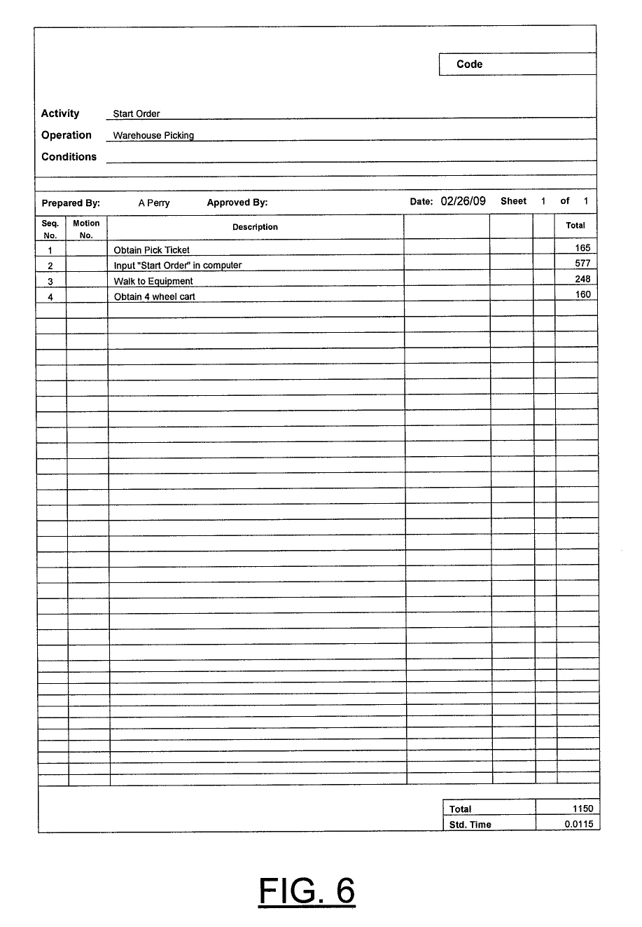

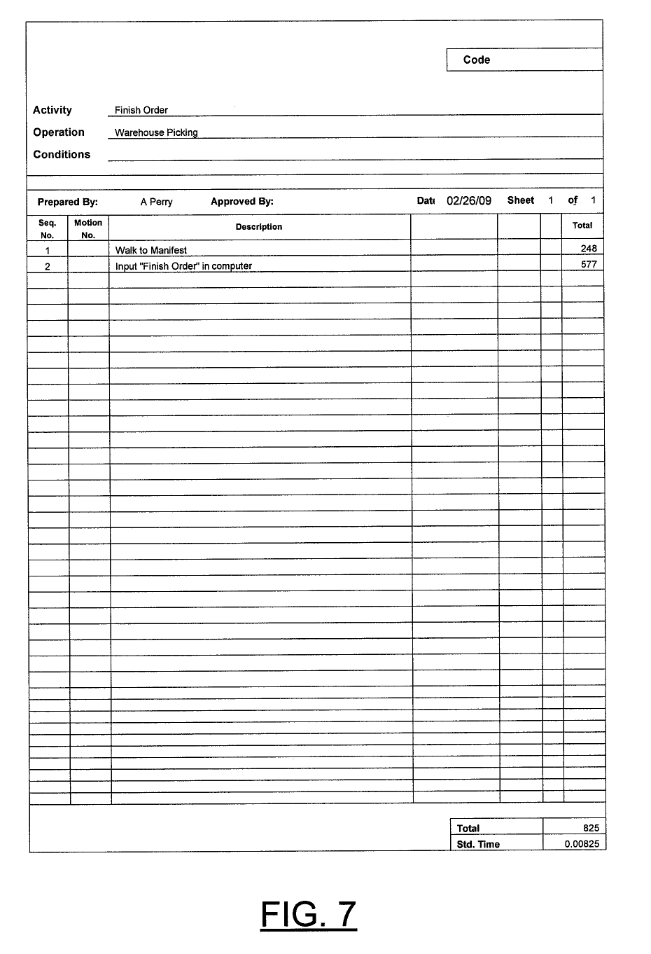

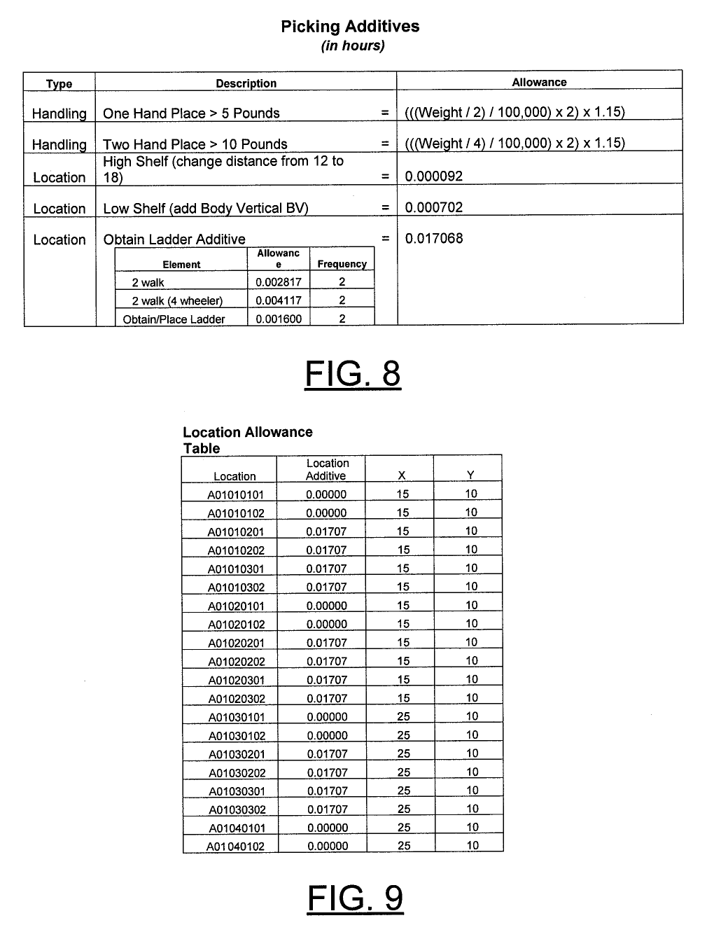

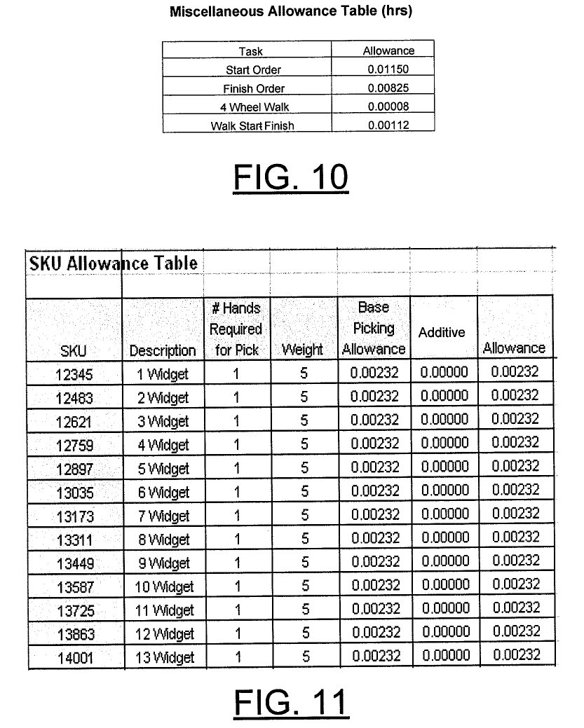

Furthermore, according to various embodiments, the discrete actions may be grouped into each data table by category and/or by when the particular action is expected to occur in the picking process. For example, in the exemplary table shown in FIG. 5, the actions are “base actions,” meaning that these actions are expected to be performed by the picker for any item on a particular pick ticket. In addition, in the exemplary table shown in FIG. 6, the actions listed therein are “start actions,” meaning that these actions are expected to be performed at the start of the picking process for any pick ticket. Similarly, in the exemplary table shown in FIG. 7, the actions listed therein are “finish actions,” meaning that these actions are expected to be performed at the end of the picking process for any pick ticket. FIG. 8 is an exemplary table listing additional allowances expected for certain handling or location requirements that may not be required to process every item. FIG. 9 is an exemplary table listing additional allowances and each x, y coordinate for various location ID logic identifiers. FIG. 10 is an exemplary table listing additional allowances for miscellaneous activities required for processing a particular pick ticket, and FIG. 11 is an exemplary table listing additional allowances for certain items (identified by the items' SKUs). These tables are described in more detail below.

A. Base Pick Allowance

The base pick allowance represents the minimum time expected for a picker to retrieve an item once the picker is at the location of the item within the warehouse. The base pick allowance includes a list of base actions that are expected to be performed by the picker and the amount of time expected to perform each action. FIG. 5 illustrates a table that includes a listing of base actions required to retrieve any item and the time allowances associated with each base action, according to a particular embodiment of the invention. In this embodiment, the base pick allowance indicates a minimal time expected for a picker to pick an item located on a mid-level shelf or rack.

According to the embodiment shown in FIG. 5, the times associated with the “Time” column is in Time Measurement Units (TMUs), which is a measure of one-one hundred thousandth (e.g., 1/100,000) of an hour. The TMU associated with each action is determined based on an average time taken to perform the action under normal conditions and/or based on certain assumptions. For example, the base pick allowance table shown in FIG. 5 includes a “Read Item to be Picked—Read 4 words” action, which refers to the action of a picker reading an item from the pick ticket, wherein there are four words on the pick ticket to be read. The time associated with this action is 5 TMUs, and the expected frequency of performing this action while the picker is picking the item is four times. Thus, the corresponding TMU for the action is multiplied by the frequency to obtain a total TMU for the action (e.g., 20 TMUs).

The sum of the total time estimates for each action are summed together in a Total column (e.g., 202 TMUs), and this sum represents the total amount of time expected for the picker to perform all of the base actions listed in the base pick allowance table. In various embodiments, this sum is converted to seconds by dividing the total number of TMUs by 100,000 and multiplying the result by 3600 (e.g., 60 seconds×60 minutes for a given hour). Thus, in the embodiment shown in FIG. 5, the base pick allowance of 202 TMUs is converted to 7.27 (or approximately 7.3) seconds.

In various embodiments, the base pick allowance table, such as the table shown in FIG. 5, is generated by the picking productivity module 87. For example, in one embodiment, the base pick allowance table is generated by the picking productivity module 87 executed by the processor 84 and is stored in the data storage unit 86 of the warehouse picking productivity device 150. In other various embodiments, the base pick allowance table is generated by the picking productivity module 87 executed by the processor 94 of the electronic computing device 91 within the warehouse and is stored in a data storage unit such as, for example, memory 96 of the electronic computing device 91.

B. Start Order Allowance

The start order allowance represents the average time expected for a picker to start the picking process. The start order allowance includes a list of start actions that are expected to be performed by the picker at the beginning of the pick process and the amount of time expected to perform each action. FIG. 6 illustrates a table that includes a listing of start actions and the time allowances associated with each start action, according to a particular embodiment of the invention. In this embodiment, the start actions include “Obtain Pick Ticket,” “Input ‘Start Order’ in computer,” “Walk to Equipment,” and “Obtain four wheeled cart”. For instance, in the embodiment shown in FIG. 6, a time of 165 TMUs is associated with the action of obtaining a pick ticket from a printer or a scanning device. Additionally, a time of 577 TMUs is associated with the action of inputting a “start order” instruction into a computing device (e.g., workstation). A time of 248 TMUs is associated with the action of walking to the equipment, and a time of 160 TMUs is associated with the action of obtaining a four-wheel cart or any other suitable equipment for storing and transferring picked items. The start order allowance is calculated by adding the times associated with each of the start actions, which results in 1150 TMUs, or 0.0115 hrs. or 41.4 seconds. The time associated with the start order allowance is utilized, in part, in determining a total pick time in which the picker is expected to pick or retrieve items identified in a pick ticket, as described more fully below in the section titled “Pick Ticket Calculations.”

In various embodiments, the start order allowance table, such as the table shown in FIG. 6, is generated by the picking productivity module 87. For example, in one embodiment, the start order allowance table is generated by the picking productivity module 87 executed by the processor 84 and is stored in the data storage unit 86 of the warehouse picking productivity device 150. In other various embodiments, the start order allowance table is generated by the picking productivity module 87 executed by the processor 94 of the electronic computing device 91 within the warehouse and is stored in a data storage unit such as, for example, memory 96 of the electronic computing device 91.

C. Finish Order Allowance

The finish order allowance represents the average time expected for a picker to finish the picking process once all of the items on the pick ticket have been retrieved. The finish order allowance includes a list of finish actions that are expected to be performed by the picker at the end of the pick process and the amount of time expected to perform each action. FIG. 7 illustrates a table that includes a listing of finish actions and the time allowances associated with each finish action, according to a particular embodiment of the invention. In this exemplary embodiment, these finish actions listed in the table include “Walk to Manifest” and “Input Finish Order in computer.” For instance, a time of 248 TMUs is associated with the finish action of walking to the manifest station 17 with the picked items that were identified in the pick ticket, and a time of 577 TMUs is associated with the finish action of inputting a finish order in a computer or workstation (e.g., electronic device 91 or DIAD 100).

The finish order allowance is calculated by adding the times associated with each of the finish actions, which results in 825 TMUs, or 0.00825 hrs. The time associated with the finish order allowance is utilized, in part, in determining a total pick time a picker is expected to pick or retrieve items identified in a pick ticket, as described more fully below in the section titled “Pick Ticket Calculations”.

In various embodiments, the finish order allowance table, such as the table shown in FIG. 7, is generated by the picking productivity module 87. For example, in one embodiment, the finish order allowance table is generated by the picking productivity module 87 executed by the processor 84 and is stored in the data storage unit 86 of the warehouse picking productivity device 150. In other various embodiments, the finish order allowance table is generated by the picking productivity module 87 executed by the processor 94 of the electronic computing device 91 within the warehouse and is stored in a data storage unit such as, for example, memory 96 of the electronic computing device 91.

D. Picking Additives

The above described exemplary tables in FIGS. 5-7 indicate base line expected target times for beginning and ending the picking process and retrieving any item within the warehouse. However, the total time expected to complete the picking process may require allowances for exceptional activities or exceptional circumstances related to items listed in the pick ticket. These additional activities and corresponding estimated times are referred to herein as picking additives. For example, additional time may be added to account for the picker's fatigue and delay (PF&D). The additional time may be a set amount (e.g., 30 TMUs) or a percentage of the total amount (or a portion of the total amount) (e.g., 15%). The additional PF&D time accounts for normal inefficiencies of a picker, including but not limited to one or more breaks (e.g., water and restroom breaks) taken by a picker. For example, according to one embodiment, the total base pick allowance shown in FIG. 5 of 202 TMUs is multiplied by 15%, which results in approximately 30 TMUs, and this amount is added to the total base pick allowance, which results in 232 TMUs. Thus, the total estimated time for performing the base pick actions listed in FIG. 5 with the additional PF&D time becomes 232 TMUs. This total time may then converted to seconds as described above, resulting in a total time of about 8.35 seconds.

FIG. 8 illustrates an exemplary table listing other types of picking additives, according to one embodiment. In particular, the table includes allowances (or algorithms for determining the allowances) for handling items exceeding a certain weight and having certain handling requirements (e.g., weighing more than five pounds and retrievable using one hand or weighing more than ten pounds and retrievable using two hands), retrieving items located on a high shelf or a low shelf, and retrieving items using a ladder. The picking additives shown in FIG. 8 are described in more detail below.

a. One Hand Place Picking Additive

The allowance associated with handling items that weigh greater than five pounds and require only one hand to obtain is calculated using the following equation: ((Weight/2)/100,000×2)×1.15. For instance, if an item on a pick ticket includes a metal block that weighs 10 pounds but is small enough to grab with one hand, the picking additive allowance calculated for the item is 0.000115 hours (e.g., (10/2/100,000×2)×1.15)=0.000115 hours). This picking additive allowance is added to the base pick allowance (e.g., 0.00232 hours) to obtain a total base pick allowance of 8.7 seconds (e.g., 0.000115+0.00232=0.002435 hours or 8.7 seconds) for retrieving the metal block.

b. Two Hand Place Picking Additive

The allowance associated with handling items that weigh greater than ten pounds and require two hands to obtain is calculated using the following equation: ((Weight/2)/100,000×2)×1.15. For example, if an item is a bowling bowl having a weight of 15 pounds, and two hands are required to retrieve the bowling ball, the picking additive allowance calculated is 0.0001725 hrs. (e.g., ((15/2/100,000×2)×1.15=0.0001725). This additional picking additive allowance is added to the base pick allowance (e.g., 0.00232) to obtain a total base pick allowance of 0.0024925 hours (e.g., 0.0001725+0.00232=0.0024925 hours) or 8.9 seconds for retrieving the bowling ball.

c. High and Low Shelf Picking Additives

The allowance associated with retrieving items located on a high shelf or rack is set at 0.000092 hours, and the allowance for retrieving items located on a low shelf or rack is set at 0.000702 hours. These additional times reflect the amount of time estimated for a picker to reach up or down 12 to 18 inches, for example, for an item located on a high or low shelf or rack. For example, for an item located on a high shelf or rack, based on the base pick allowance shown in FIG. 5 and the picking additive allowance shown in FIG. 8, the picker is expected to spend 0.002412 hours or 8.68 seconds retrieving the item. Similarly, for an item located on a low shelf or rack, based on the base pick allowance shown in FIG. 5 and picking additive allowance shown in FIG. 8, the picker is expected to spend 0.003022 hours or 10.88 seconds retrieving the item. These additional times allow the picker more time to obtain items located on high or low shelves or racks.

d. Obtain Ladder Picking Additive

A picking additive is also provided in FIG. 8 for circumstances in which a picker is required to obtain a ladder to retrieve an item. For example, the picking additive allowance includes a series of actions for retrieving the ladder (referred to herein as a “2 walk” action) and the time expected to perform the actions. For example, the “2 walk” action according to one embodiment includes walking to an area of a warehouse (e.g., the portable stair storage station 10) to obtain a ladder using the ladder to pick the item, and walking back to the portable stair storage station 10 to return the ladder. This series of actions is associated with picking additive allowance of 0.002817 hours, representing the amount of time expected to perform the actions. If the ladder has rollers, the action is referred to herein as a “2 walk (4 wheeler)” action, and the steps of the action include walking to retrieve the ladder, using the ladder to pick an item, and then returning the ladder to the portable stair storage station 10. The 2 walk (4 wheeler) action is associated with a picking additive allowance of 0.004117 hours. Furthermore, the action associated with obtaining and placing the ladder in a position in which the ladder is used to pick an item is assigned a picking additive allowance of 0.001600 hours.

In various embodiments, the picking additive allowances are generated by the picking productivity module 87. For example, in one embodiment, the picking additive allowances are generated by the picking productivity module 87 executed by the processor 84 and are stored in the data storage unit 86 of the warehouse picking productivity device 150. In other various embodiments, the picking additive allowances are generated by the picking productivity module 87 executed by the processor 94 of the electronic computing device 91 within the warehouse and is stored in a data storage unit such as, for example, memory 96 of the electronic computing device 91.

e. Location Additives

The total time expected to complete the picking process may also require allowances for the location of one or more of the items to be retrieved. For example, a picker may be able to access items disposed on a mid-level of a rack than items located on higher or lower levels of the rack. The actions required to access the items disposed in exceptional locations and the corresponding estimated times for performing these actions are referred to herein as location additives. For example, as illustrated in the table shown in FIG. 9, according to one embodiment, items located at level 01 are associated with a location additive allowance of 0 because level 01 is considered a normal level. However, items located at level 02, which is higher than level 01, are associated with a location additive allowance of 0.01707 hours because the time expected to retrieve items from level 02 is more than the time expected for retrieving items from level 01. As described more fully below in the section entitled “Pick Ticket Calculations,” the location additive allowances are included in estimating the total expected time for processing a pick ticket.

In addition, in the embodiment shown in FIG. 9, the location additive allowance table also contains the x-y coordinates of locations for the location ID logic identifiers listed in the table. As described more fully below in the section titled “Pick Ticket Calculations”, these x-y coordinates are utilized to determine travel distances and the corresponding travel times between various locations within the warehouse.

In various embodiments, the location additive allowances are generated by the picking productivity module 87. For example, in one embodiment, the location additive allowances are generated by the picking productivity module 87 executed by the processor 84 and are stored in the data storage unit 86 of the warehouse picking productivity device 150. In other various embodiments, the location additive allowances are generated by the picking productivity module 87 executed by the processor 94 of the electronic computing device 91 within the warehouse and is stored in a data storage unit such as, for example, memory 96 of the electronic computing device 91.

f. Miscellaneous Allowance Table

Various embodiments further provide for other types of additive allowances. The table shown in FIG. 10 lists miscellaneous additive allowances according to one embodiment, which include miscellaneous actions to be performed by the picker and the time expected to perform each action. For example, in the embodiment shown in FIG. 10, the table includes the start order allowance of 0.0115 hours described above in relation to FIG. 6, the finish order allowance of 0.00825 hours described above in relation to FIG. 7, a four wheel walk allowance of 0.00008 hours, and a walk start-finish allowance of 0.00112 hours. The four wheel walk allowance represents an average time expected for the picker to start and stop the pushing of a device designed for transporting (e.g., four wheel cart or wheel bearer) one or more picked items. The walk start-finish allowance corresponds to a time expected for the picker to begin walking and stop walking during the retrieval of an item to be picked.

g. Stock Keeping Unit Allowance Table

Various embodiments also provide for stock keeping unit (SKU) additives based on the particular SKU for the item. For example, the SKU additive for a particular item may reflect special handling instructions required of the picker, such as those described above in relation to FIG. 8. FIG. 11 illustrates a SKU allowance table listing various SKUs and any additive time associated with each SKU according to one embodiment. The SKU allowance table also includes descriptive information related to each SKU, the number of hands required to pick each item, the weight of each item, the base pick allowance for each item, and the total pick allowance for each item, which includes the base pick allowance and any picking additives associated with each item. Although there are no picking additives provided in the SKU allowance table of FIG. 9 as indicated that by the value “0.00000” in the “Additive” column, the SKU allowance table may include any suitable picking additives. For example, the picking additives described above with respect to FIG. 8 based on the weight and/or size of the item as well as the handling requirements for the particular item may be associated with one or more of the SKUs. As an example, if a SKU of 14003 associated with “14 Widget” (not shown) corresponds to the bowling ball described above in relation to FIG. 8, a corresponding weight of 15 is included in the SKU allowance table and a “2 hand pick” handling instruction is identified. Additionally, the base pick allowance of 0.00232 is added to the picking additive allowance of 0.0001725 hours to obtain a total pick allowance of 0.0024925 hours (e.g., 0.0001725+0.00232=0.0024925 hours) for the item.

### General System Operation

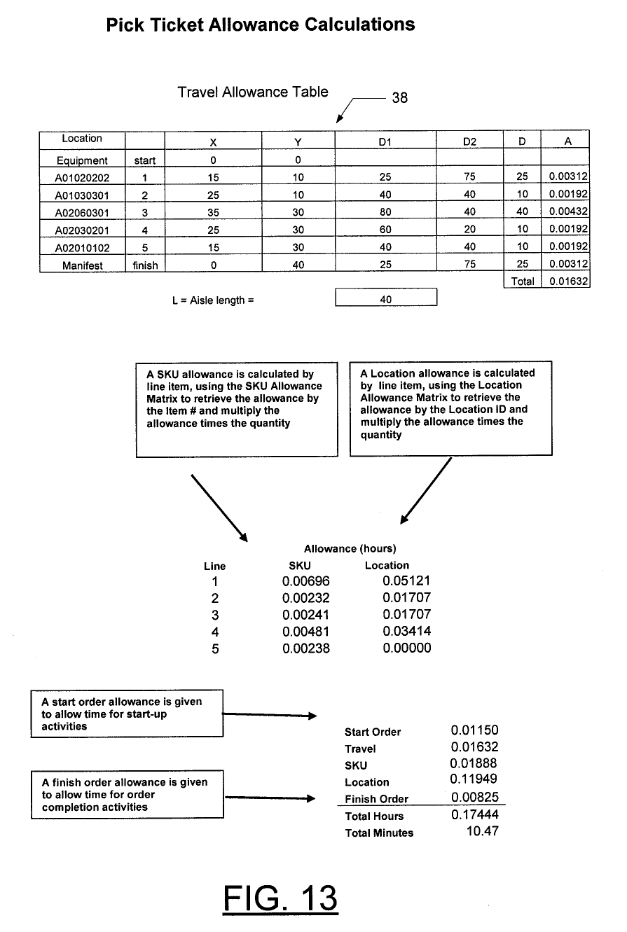

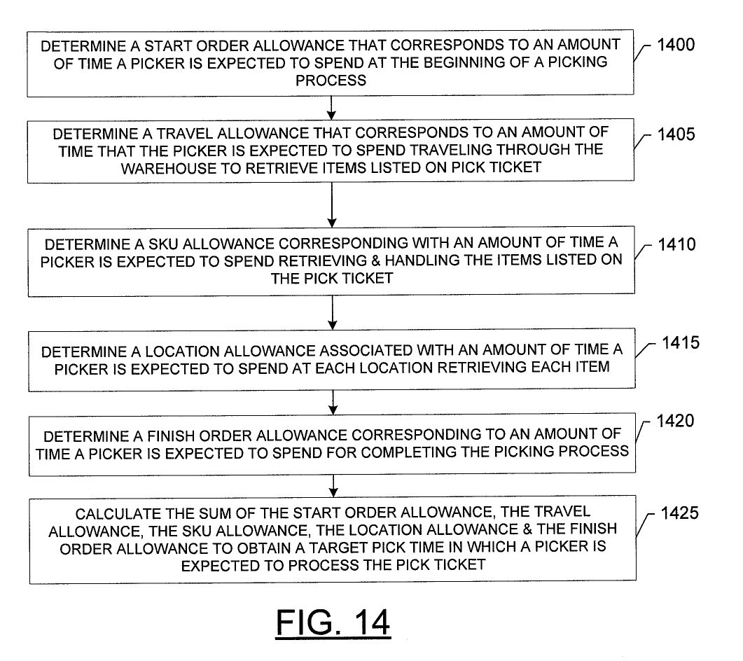

Reference is now be made to FIGS. 12-14, which illustrate an exemplary embodiment of a pick ticket generated by the system 7 (shown in FIG. 12), tables (shown in FIG. 13) illustrating at least a portion of the data used to calculate the target pick time specified on the pick ticket, and a method of calculating the target pick time (shown in FIG. 14).

A. Generation of Pick Ticket

Referring now to FIG. 12, an exemplary embodiment of a pick ticket is illustrated. According to various embodiments, the pick ticket is generated by the picking productivity module 87 and is sent to a workstation (e.g., electronic computing devices 91) in the base station 18 of the warehouse in which the pick ticket is to be processed. The pick ticket is then printed via a printer of the workstation, and a paper-based version of the pick ticket is reviewed by the individual assigned to process the pick ticket (e.g., the picker). Alternatively, the pick ticket is transmitted to a DIAD 100 accessible to the picker, and the picker reviews an electronic version of the pick ticket via a display of the DIAD 100.

According to various embodiments, the pick ticket is generated by an institution (e.g., a shipping or warehousing entity) on behalf of an order placed by another institution or individual, referred to herein as the recipient. In this regard, when the items identified in the pick ticket are picked and packaged, the packaged items are arranged for delivery to the recipient.

Various embodiments of the pick ticket include one or more line items that are each associated with respective items to be retrieved by the picker, one or more verification lines for receiving input regarding the quantity of each item actually retrieved, and a target pick time for processing the pick ticket. For instance, the exemplary embodiment of the pick ticket of FIG. 12 contains five line items. In particular, line item 1 corresponds to an item described as “10 Widget,” line item 2 corresponds to an item described as “17 Widget,” line item 3 corresponds to an item described as “71 Widget,” line item 4 corresponds to an item described as “51 Widget,” and line item 5 corresponds to an item described as “38 Widget.” Each line item includes an item number or SKU number (e.g., 13587) and a corresponding location identifier (e.g., A01020202) that identifies a location of the item within the warehouse. Additionally, each line item includes a quantity (e.g., 3) of the item (e.g. item “10 Widget” assigned SKU number 13587) that the picker is required to retrieve from the item's corresponding location (e.g., A01020202).

In an embodiment in which the pick ticket is printed for the picker, the picker inputs the quantity actually retrieved for each item listed on the pick ticket after the items are retrieved by writing the actual quantity retrieved on the verification line corresponding to the particular item retrieved. However, in an embodiment in which the pick ticket is displayed for the picker on a DIAD 100 or other electronic computing device, the picker may input the actual quantity received using a keypad or other input device of the computing device (e.g., scanning a bar code on each item as it is retrieved, voice input, track wheel selection, or other suitable input device).

As noted above, the target pick time is included on the pick ticket to communicate to the picker the amount of time expected for the picker to process the pick ticket. For example, in the embodiment shown in FIG. 12, the target pick time included in the pick ticket is 10.47 minutes. The manner in which the target pick time is calculated is described in more detail below.

B. Pick Ticket Calculations

According to various embodiments, the target pick time for processing a particular pick ticket is the sum of time estimates associated with various discrete actions that are required for retrieving the one or more items listed on the pick ticket and delivering them to a manifest station for packing and shipping to the intended recipient. For example, according to various embodiments, the target pick time is the sum of the start order allowance, the finish order allowance, a travel allowance, an SKU allowance associated with each item to be retrieved on the pick ticket, and a location allowance. In various other (or further) embodiments, the target pick time may also include one or more of the four wheel walk allowance, the walk start-finish allowance, and any other suitable allowances (e.g., additive allowances).

1. Travel Allowance

The travel allowance relates to the amount of time in which the picker is expected to travel between locations to process the pick ticket. According to various embodiments, the travel allowance is calculated by a processor (e.g., processor 84 or 94) executing the picking productivity module 87, and the travel allowance is based on one or more variables, equations, and travel distances between locations in a warehouse. In certain embodiments, each location within the warehouse corresponds to a particular x, y coordinate, and these coordinates are used to calculate the distance between two locations in the warehouse.
For example, in one embodiment, the variables, equations, and logic implemented by the picking productivity module 87 in calculating the travel allowance include the following:
X1=X axis value for start location;
Y1=Y axis value for start location;
X2=X axis value for end location;
Y2=Y axis value for end location;
D1=Distance traveled between start and end locations if traveling in a clockwise direction=X1+(Y2−Y1)+X2;
D2=Distance traveled between start and end locations if traveling in a counter clockwise travel direction=(L−X1)+(Y2−Y1)+(L−X2);
L=Aisle length;
D=Shortest travel distance between two locations;
Walk Start-Finish Travel Allowance=0.00112 hours;
Four wheel Walk Travel Allowance=0.00008 hours;
A=Line Travel Allowance=Walk Start-Finish Travel Allowance+D(Four Wheel Walk Travel Allowance)=0.00112+D(0.00008); and
If Y2−Y1=0, then D=|X2−X1| (absolute value of X2−X1), Else if D2<D1, then D=D2, and else if D1<D2, then D=D1.

FIG. 13 illustrates a travel allowance table 38 according to one embodiment that includes data used to calculate the travel allowance for the pick ticket shown in FIG. 12 based on the warehouse layout shown in FIG. 4. In particular, the first column of the table 38 reflects the order in which the picker should travel from the base station 18 to process the pick ticket according to the pick routing plan determined by the picking productivity module 87. For example, the equipment station 19 is listed as the start location, and the location ID logic identifiers associated with each item to be retrieved are listed thereafter in the order in which they are to be retrieved. Finally, the manifest station 17 is listed as the finish location.

In addition, the x coordinate and y coordinate associated with each station and each location ID logic identifier are listed in a respective X column and Y column in table 38. For example, in the embodiment shown in FIG. 13, the x, y coordinates associated with each location assume that the equipment station 19 of the warehouse corresponds with an x-y coordinate of (0, 0), and the location of the manifest station 17 corresponds with an x-y coordinate (0, 40).

Referring to FIG. 4, the distance that a picker travels along the x-axis 39 (shown in FIG. 4) from the equipment station 19 to a pick location 40 associated with the first location ID logic identifier A01020202 is 15 feet. On the other hand, the distance that a picker must travel along the y-axis 50 from the equipment station 19 to the pick location 40 associated with the first location ID logic identifier A01020202 is 10 feet (e.g. midpoint of y-axis 50 is 10 feet). The travel distances along the x-axis 39 and the y-axis 50 are included in the respective X and Y columns associated with the location identifier A01020202 in the travel allowance table 38.

Using the equations listed above, the picking productivity module 87 calculates the distances traveled if traveling in a clockwise direction (D1) and a counter clockwise direction (D2), which are shown in the D1 and D2 columns, respectively. In particular, building on the above example, the distance traveled in the clockwise direction (D1) between the equipment station 19 and the pick location associated with the first location ID logic identifier A01020202 is 25 (e.g., D1=0+(10−0)+15=25), and the distance traveled in the counter clockwise direction (D2) between the equipment station 19 and the pick location associated with the first location ID logic identifier A01020202 is 75 (e.g., D2=(40−0)+(10−0)+(40−15)=75).

D1 and D2 are then compared by the picking productivity module 87 to identify the shortest travel distance (D) between the two locations. Because D1 is less than D2 in this example, the shortest travel distance (D) is set to be equal to D1 (i.e., 25 feet in this example). In addition, the picking productivity module 87 then determines that the line travel allowance between these two positions (A) is 0.00312 hours based on the calculation A=0.00112+25(0.00008)=0.00312 hours. The line travel allowance for pick locations associated with location ID logic identifiers A01030301, A02060301, A02030201, and A02010102 as well as the location of the manifest station 17 are determined in a manner analogous the description above with respect to travel between the equipment station 19 and the pick location associated with location ID logic identifier A01020202. In particular, in the exemplary embodiment of FIG. 13, the line travel allowances associated with travel to the pick locations corresponding to location ID logic identifiers A01030301, A02060301, A02030201, and A02010102 as well as the manifest section 17 equals 0.00192 hours, 0.00432 hours, 0.00192 hours, 0.00192 hours and 0.00312 hours, respectively.

The picking productivity module 87 calculates the sum of the line travel allowances associated with travel to the pick locations associated with each location ID logic identifier and to the manifest station 17 to obtain the travel allowance of 0.01632 hours (e.g., 0.00312 hours+0.00192 hours+0.00432 hours+0.00192 hours+0.00192 hours+0.00312 hours=0.01632 hours).

2. SKU Allowance

As noted above with respect to FIGS. 5, 8, and 11 and in the section entitled “Picking Additives,” certain items may be retrieved in an average amount of time, and other items may require additional time (e.g., because of their size, weight, and/or handling restrictions). Thus, according to various embodiments, each item, which is associated with a unique SKU number, is further associated with a SKU allowance representing the amount of time expected to retrieve each item. For example, FIG. 11 illustrates a SKU allowance table that lists various SKU numbers and the SKU allowance associated with each item. According to various embodiments, the SKU allowance is the sum of the base pick allowance and any picking additives.

In calculating the target pick time for the pick ticket, the picking productivity module 87 calculates the total SKU allowance for each item on the pick ticket by multiplying the quantity of each item to be retrieved with the SKU allowance associated with the item (e.g., the SKU allowance shown in FIG. 11). For example, according to FIG. 11, SKU number 13587 has an allowance of 0.00232 hours, and the pick ticket of FIG. 12 indicates that three items having SKU number 13587 are required to be retrieved. As such, the picking productivity module 87 multiplies the quantity, which is three in this example, by the SKU allowance for the item, which is 0.00232 hours, to obtain a total SKU allowance of 0.00696 hours for the particular item. The total SKU allowance for each item in the pick ticket is calculated in a similar manner, and total SKU allowances for the items on the pick ticket in FIG. 12 are shown in FIG. 13 by reference to the line item number associated with the item in the pick ticket.

The total SKU allowance for the pick ticket is then calculated by determining the sum of the total SKU allowances associated with each item on the pick ticket. Referring back to the exemplary embodiment shown in FIG. 12, the picking productivity module 87 adds all of the SKU allowances associated with line items 1 to 5 to obtain the SKU allowance for the pick ticket of 0.01888 hours.

3. Location Allowance

As noted above with respect to FIGS. 8 and 9 and in the section entitled “Location Additives,” retrieving items from certain locations may require an average amount of time, and retrieving items from other locations may require additional time (e.g., because the items are located above or below a certain height). Thus, according to various embodiments, location additive allowances are included in the amount of time expected to retrieve items disposed in certain locations within the warehouse. For example, FIG. 9 lists location additive allowances associated with various location ID logic identifiers.

In calculating the target pick time for the pick ticket, the picking productivity module 87 calculates the total location allowance for each item on the pick ticket by multiplying the quantity of each item to be retrieved with the location allowance associated with the item's location (e.g., the location allowance shown in FIG. 9). For example, FIG. 13 illustrates the total location allowance associated with each line item in the pick ticket shown in FIG. 12. In particular, line item 1 of the pick ticket shown in FIG. 12 corresponds to location ID logic identifier A01020202, and this location ID logic identifier is associated with a location allowance of 0.01707 hours. Because the pick ticket requests that three of these items be retrieved, the picking productivity module 87 multiplies the location allowance of 0.01707 hours by three to calculate the total location allowance for line item 1 of 0.05121 hours. The total location allowance for each item in the pick ticket is calculated in a similar manner, and total location allowances for the items on the pick ticket in FIG. 12 are shown in FIG. 13 by reference to the line item number associated with the item in the pick ticket.

The total location allowance for the pick ticket is then calculated by determining the sum of the total location allowances associated with each item on the pick ticket. Referring back to the exemplary embodiment shown in FIG. 12, the picking productivity module 87 adds all of the location allowances associated with line items 1 to 5 to obtain the location allowance for the pick ticket of 0.11949 hours.

4. Using the Allowances to Determine the Target Pick Time

The picking productivity module 87 calculates the sum of the various allowances to determine the target pick time associated with the pick ticket. For example, as shown in FIG. 13, the target pick time of 10.47 minutes is the sum of the start order allowance of 0.01150 hours, the total travel allowance of 0.01632 hours, the total SKU allowance of 0.01888 hours, the total location allowance of 0.11949 hours, and the finish order allowance of 0.00825 hours. As such, a picker is expected to pick or retrieve all of the items identified in the pick ticket of FIG. 12 within 10.47 minutes.

FIG. 14 illustrates one embodiment of method steps executed by a processor (e.g., processor 84, 94) executing the picking productivity module 87 for calculating a target pick time. Beginning at Step 1400, the processor determines a start order allowance that corresponds to an amount of time a picker is expected to spend at the beginning of the picking process. At Step 1405, the processor determines a travel allowance that corresponds to an amount of time that the picker is expected to spend traveling through the warehouse to retrieve the items listed on the pick ticket. At Step 1410, the processor determines a SKU allowance corresponding with an amount of time the picker is expected to spend retrieving and handling the items listed on the pick ticket. At Step 1415, the processor determines a location allowance associated with an amount of time the picker is expected to spend at each location retrieving each item (e.g., based on the height of an access point (e.g., a rack or shelf storing items) of each location). And, at Step 1420, the processor determines a finish order allowance corresponding to an amount of time that the picker is expected to spend for completing the picking process. Finally, at Step 1425, the processor calculates the sum of the start order allowance, the travel allowance, the SKU allowance, the location allowance, and the finish order allowance to obtain a target pick time in which the picker is expected to process the pick ticket.

According to various embodiments, Steps 1400 through 1420 may be performed in any order, not just the order shown in FIG. 14. Furthermore, in various other embodiments, the target pick time does not include the start order allowance or the finish order allowance but includes the sum of the travel allowance, the SKU allowance, and the location allowance (e.g., as determined in Steps 1405, 1410, and 1415, respectively).

### Generation of Reports Summarizing Productivity of Employees

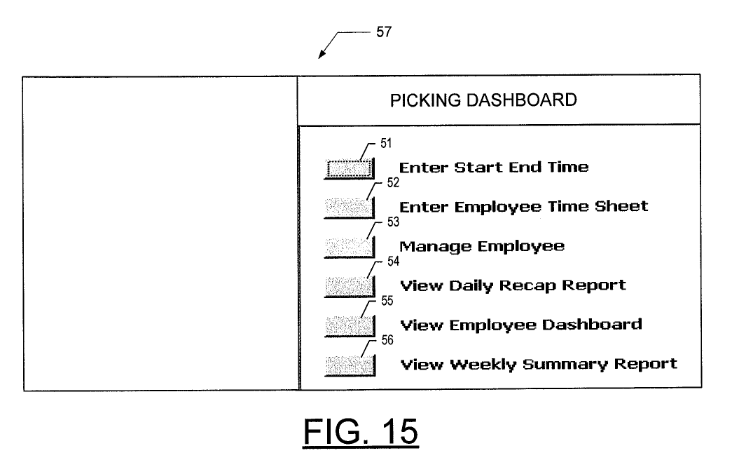

Various embodiments of the invention provide for the generation of reports summarizing the productivity of employees assigned as pickers, and these reports may vary in the level of detail provided for a particular employee or group of employees. Data used to generate the reports may be entered manually or may be captured through other activities of the system, and this data may be manipulated by a user via various graphical user interfaces. FIGS. 15-26 illustrate exemplary embodiments of these graphical user interfaces and the types of reports that may be generated by the system.

FIG. 15 illustrates a graphical user interface of a picking dashboard 57 according to one embodiment of the invention. A processor (e.g., processor 84, 94) of a computing device (e.g., warehouse picking productivity device 150, electronic computing device 91) causes the picking dashboard to be displayed to a user, and the picking dashboard 57 displays various options for interacting with the picking productivity module 87. In particular, the picking dashboard 57 includes an “enter start end time” tab 51, an “enter employee time sheet” tab 52, a “manage employee” tab 53, a “view daily recap report” tab 54, a “view employee dashboard” tab 55, and a “view weekly summary report” tab 56. In various embodiments, the picking dashboard 57 is configured to be shown on a display (e.g., display 80, 90) of the computing device, and selection of any of the tabs of the picking dashboard 57 causes a different graphical user interface to be displayed to the user, as described below.

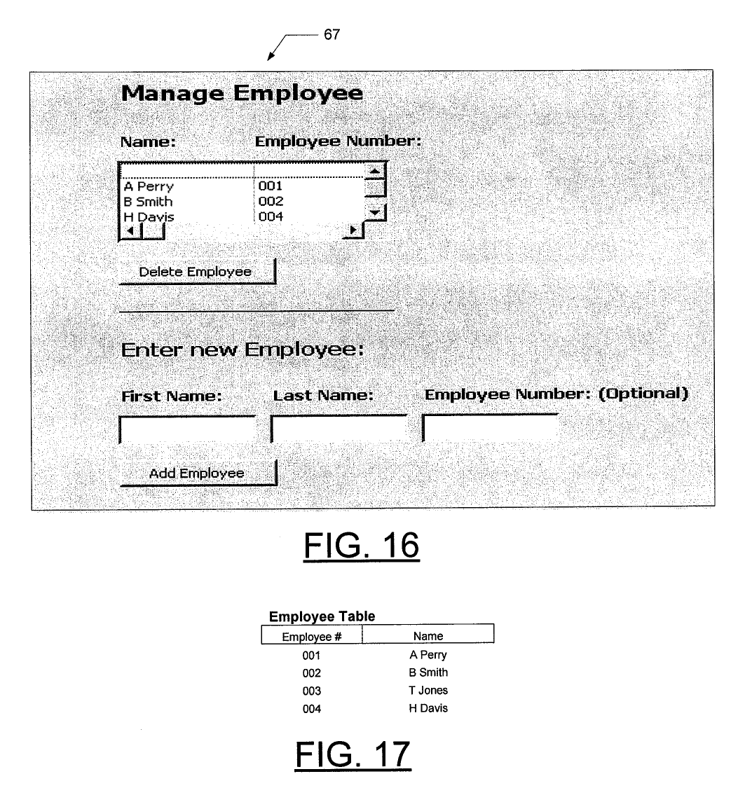

Referring now to FIG. 16, an exemplary embodiment of a graphical user interface 67 for managing employees is provided. The graphical user interface 67 is generated by the processor of the computing device upon selection of the “manage employee” tab 53 of the picking dashboard 57. The user is able to add data to or remove data from the exemplary employee table shown in FIG. 17 via the graphical user interface 67. The data in the employee table, according to various embodiments, identifies one or more employees that may be utilized as pickers, and each employee is associated with a unique employee identifier (e.g., employee A. Perry is associated with employee identifier 001).

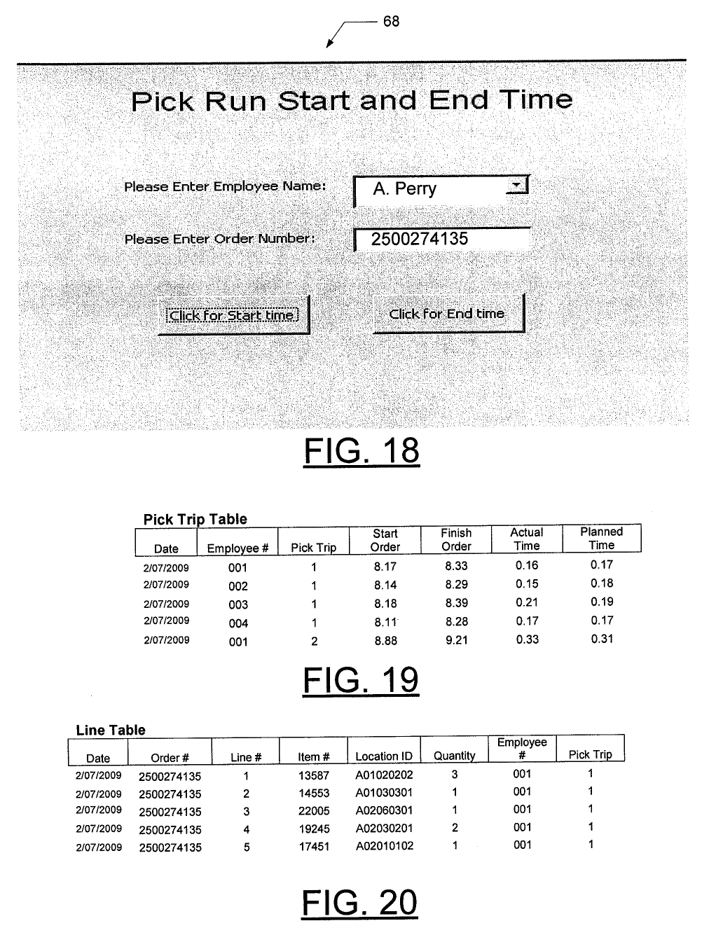

FIG. 18 illustrates a graphical user interface 68 according to one embodiment for inputting start pick trip and end pick trip times. Data from the pick trip table shown in FIG. 19 and the line table shown in FIG. 20 may also be updated or retrieved via this graphical user interface 68. The graphical user interface 68 is generated by the processor of the computing device upon selection of the “enter start end time” tab 51 of the picking dashboard 57. As shown in FIG. 18, the user enters an order number (e.g., 2500274135) (or a pick ticket number) into a field of the graphical user interface 68, and in response, data associated with the order (or the pick ticket) is retrieved from a line table such as the line table shown in FIG. 20. Additionally, the graphical user interface 68 is used to record a time that the picking process for the order was started (e.g., 8.17 hours—as measured from 12:00 AM) by the picker (e.g., A. Perry identified by identifier “001”) and a time that the order was completed (e.g., 8.33—as measured from 12:00 AM). This data is stored in the pick trip table shown in FIG. 19 according to various embodiments.

The pick trip table shown in FIG. 19 also includes data illustrating the actual time that it took the employee to complete the picking process as well as the target pick time estimated for the pick ticket associated with the order. For instance, as shown in FIG. 19, employee A. Perry, identified by identifier “001,” completed pick trip 1 in 16 hundredths of an hour (e.g., “0.16”). However, the target pick time for pick trip 1 was 17 hundredths of an hour. In this regard, employee A. Perry was efficient and productive in completing pick trip 1 since A. Perry completed the pick trip one hundredth of an hour faster than the target pick time corresponding to pick trip 1. In contrast, employee T. Jones, identified by identifier “003”, was inefficient by two hundredths of an hour since he completed the pick trip in 21 hundredths of an hour and the target pick time for T. Jones was 19 hundredths of an hour.

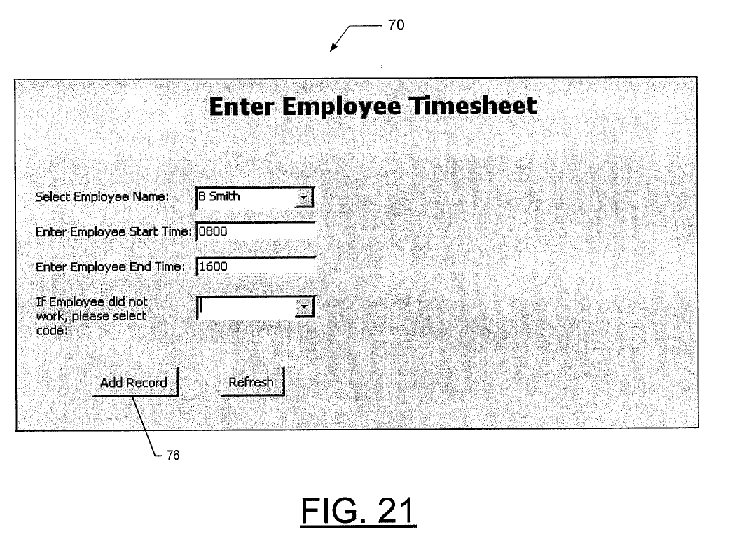

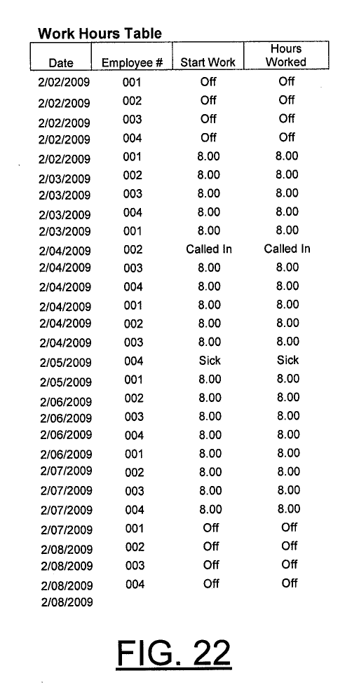

FIG. 21 illustrates a graphical user interface 70 according to one embodiment for entering one or more employee work hours. The graphical user interface 70 is generated by the processor of the computing device upon selection of the “enter employee time sheet” tab 52 of the picking dashboard 57. In particular, the graphical user interface 70 is utilized to enter the start and end work times of employees for a given day and to specify that an employee is not scheduled to work (e.g., the employee is off) or is not able to work an assigned shift. This data is saved to a work hours table such as the table shown in FIG. 22 upon selecting the “add record” button 76.

As described below, the processor retrieves and utilizes the data in the employee table, the line table, the pick trip table, and/or the work hours table to generate one or more reports summarizing the productivity of employees picking items in a warehouse. For example, the types of reports generated according to various embodiments include an employee production summary report, an employee production detail summary report, a daily summary recap report, and a weekly production summary report.

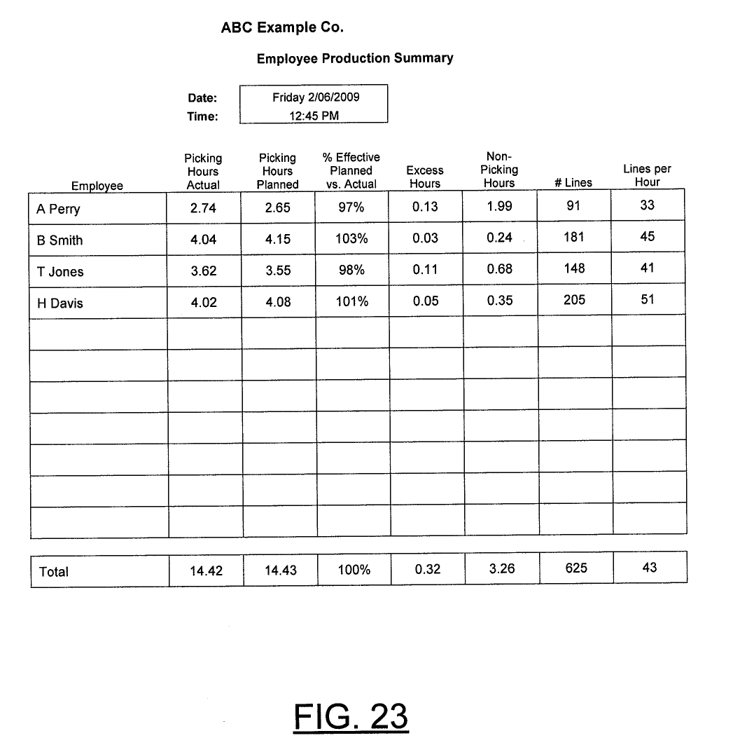

FIG. 23 illustrates an employee production summary report according to one embodiment that illustrates the productivity of a particular employee assigned to pick items in a warehouse for a given day or time period. The employee production summary report is generated by the processor of the computing device upon selection of the “view employee dashboard” tab 55 of the picking dashboard 57.

To generate the report shown in FIG. 23, the processor retrieves data corresponding to the actual picking hours spent by the employee (in this example, A. Perry) and the target picking hours for the employee during the time period (in this example, one day). For example, as shown in FIG. 23, A. Perry had actual picking hours of 2.74 hours and target picking hours of 2.65 hours for the given day (e.g., Feb. 6, 2009). The processor uses this data to calculate the efficiency of the employee for the given day. Here, the efficiency of A. Perry is 97% (2.65target picking hours/2.74 actual picking hours). The processor also uses this data to calculate the excess hours worked by employee A. Perry for picking activities. Here, the excess hours spent by A. Perry for picking activities is 0.13 hours (2.74 hours−2.65 hours), meaning that A. Perry took more than the target time allocated (also referred to herein as “over-allowed”) to complete one or more assigned pick trips.

Additionally, the processor determines the non-picking hours associated with one or more employees. The non-picking hours relate to hours in which the employee was not actually picking items associated with a pick ticket. As an example, if an employee completes a picking order at 8:20 AM but does not begin the next pick order until 8:53 AM, the employee is considered to not be performing picking activities between 8:20 AM and 8:53 AM, which results in a non-picking time of 33 minutes, or 0.55 hours. In this regard, the processor is configured to retrieve data indicating the start and end times associated with various pick trips to identify the non-picking hours spent by the employee during a particular time period. In the embodiment shown in FIG. 23, the processor determined that the non-picking hours associated with A. Perry was 1.99 hours.

The processor is also configured to determine a total number of line items assigned to each employee based on all pick tickets assigned to the employee during in a particular time period. In particular, the processor is configured to retrieve data from a line table that includes the line items processed, the employee that processed each line item, and the corresponding quantity, location, SKU number, and description of the item associated with each line item. FIG. 20 illustrates an exemplary line table according to one embodiment. The processor then sums the total number of line items assigned to a particular employee for the particular time period. As shown in FIG. 20, A. Perry was assigned 91 line items in one day.

Furthermore, according to various embodiments, the number of line items per hour picked (also referred to herein as “lines per hour”) is one way in which the productivity of an employee may be measured. The lines per hour for a particular employee is determined by the processor by dividing the total number of line items assigned to the employee by the actual picking hours spent by the employee. The lines per hour calculated by the processor indicates the number of items picked during a total number of hours worked by the employee during the time period. As shown in FIG. 23, the processor determined that the lines per hour associated with A. Perry is 33 (e.g., 91 line items divided by 2.74 hours=33 lines per hour).

The processor is also configured to determine that the total lines per hour, total number of excess hours, total number of non-picking hours, and the overall efficiency for all of the employees during a particular time period. For example, in the example report shown in FIG. 23, the total lines per hour for all employees is 43 (e.g., 625/14.42 hours=43), the total number of excess hours is 0.32 hours, the total number of non-picking hours is 3.26 hours, and the overall efficiency of the employees is approximately 100% (e.g., total actual picking hours of 14.42 hours/total planned picking hours of 14.43 hours). Thus, personnel of a distribution center can determine the productivity of the employees during a given time period at-a-glance.

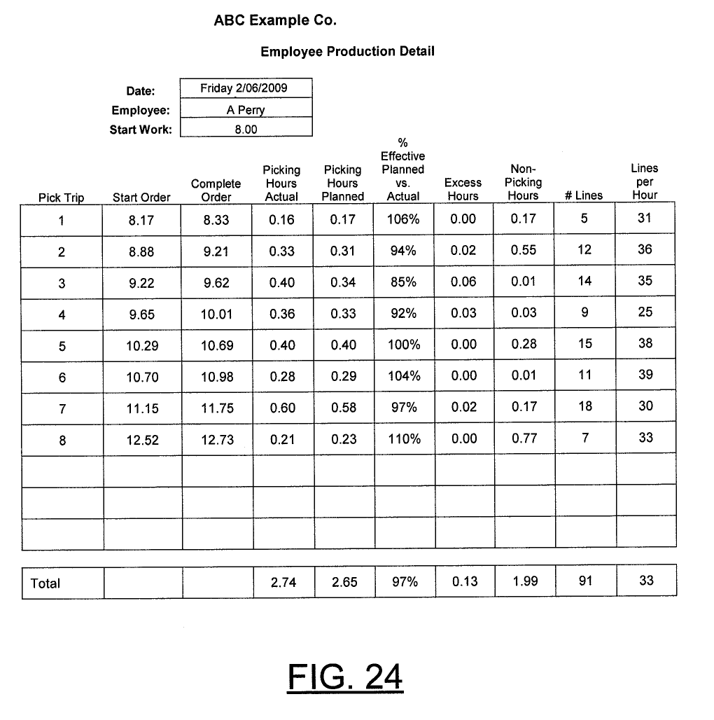

According to various embodiments, the processor may generate an employee production detail summary report that illustrates the productivity of an employee picking items in a warehouse for a given time period. For example, the employee production detail summary report identifies pick trips performed by a particular employee. The employee production detail summary report is generated by the processor upon selection of one or more links associated with an employee identified in the employee production summary report, such as the report shown in FIG. 23. According to certain embodiments, the employee production detail summary report is configured to be generated based, in part, on data stored in the pick trip table of FIG. 19. FIG. 24 illustrates an exemplary employee production detail summary report according to one embodiment.

The employee production detail summary shown in FIG. 24 identifies pick trips that are performed by A. Perry. To generate the report, the processor determines that employee A. Perry began pick trip 1 at 8:10 AM (e.g., 8.17 hours—as measured from 12:00 AM) and completed pick trip 1 at 8:20 AM (e.g., 8.33 hours—as measured from 12:00 AM) resulting in actual picking hours of 0.16 hours (e.g., 8.33−8.17=0.16). The processor determines that the target picking hours associated with pick trip 1 is 0.17 hours and the efficiency of A. Perry associated with pick trip 1 is 106% (e.g., 0.17 hours/0.16 hours×100%=106%). Since employee A. Perry completed pick trip 1 in less time than was planned, there are no excess hours. Additionally, the processor is configured to determine that the non-picking hours related to pick trip 1 is 0.17 hours and that the number of line items corresponding to the pick trip 1 is five. The processor is also configured to determine that the number of line items per hour picked is 31. The data associated with pick trips 2-8 in the employee production detail summary report are generated in a manner analogous to that discussed above with respect to pick trip 1.

According to various embodiments, a daily production recap report is generated by the processor upon selection of the “view daily recap report” tab 54 of the picking dashboard 57. The daily production recap report indicates the productivity of employees picking items in a warehouse during a given day (e.g., Friday Feb. 6, 2009). At least a portion of the data in the daily production recap report is retrieved by the processor from a work hours table (such as shown in FIG. 22) and a pick trip table (such as shown in FIG. 19).

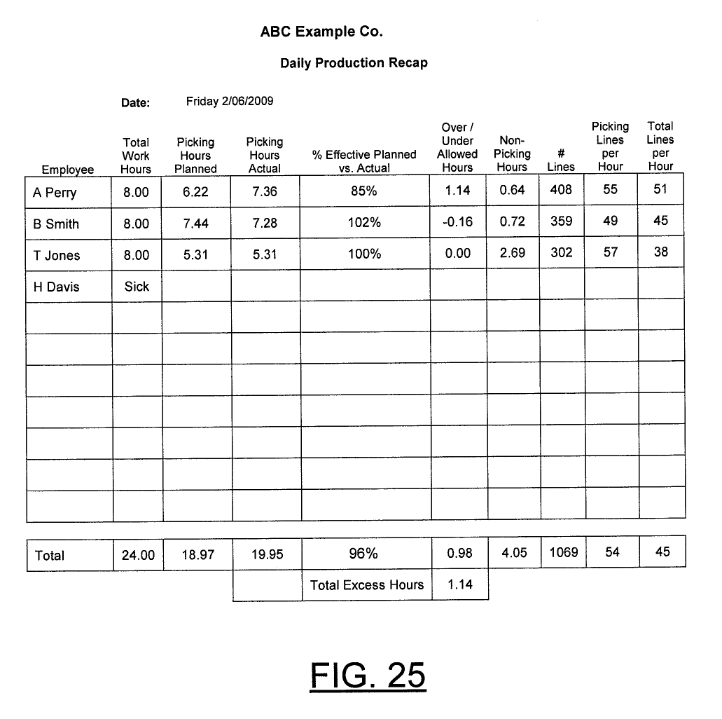

FIG. 25 illustrates an exemplary embodiment of a daily production recap report. As an example of the summary data that the processor generates with respect to an employee in the daily production recap report, consider employee A. Perry. In particular, the processor retrieves (or determines) the actual picking hours of A. Perry on Feb. 6, 2009 of 7.36 hours and the planned picking hours of 6.22 hours. In this regard, the processor is configured to determine that A. Perry was 85% efficient and that A. Perry was over allowed (e.g., inefficient) by 1.14 hours. The processor is also configured to determine that the non-picking hours for A. Perry was 0.64 hours and the number of line items handled by A. Perry was 408. Additionally, the processor determines that the number of picking lines per hour is 55 (e.g., 408/7.36 hours=55). The processor also determines that the total lines per hour is 51 (e.g., 408/8 hours=51).

The processor determines that the total excess hours is 1.14 hours since A. Perry was the only employee that required time in excess of the target picking time to complete the picking process. In contrast to A. Perry, the processor determines that employee B. Smith completed the process of picking items in less time than was allocated, which means that B. Smith is under allowed by 0.16 hours (e.g., 7.28−7.44=−0.16)

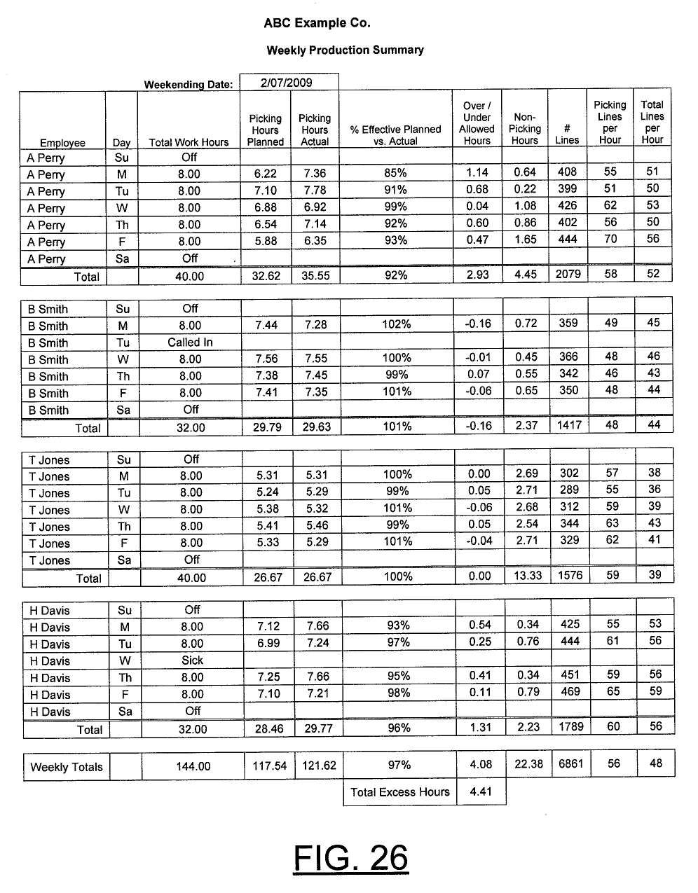

Various embodiments provide for the generation of a weekly production summary report that indicates the productivity of employees during a given week. FIG. 26 illustrates an exemplary embodiment of a weekly production summary report. According to various embodiments, the processor is configured to generate the weekly production summary report in response to a selection of the “view weekly summary report” tab 56 of the picking dashboard 57. The weekly production summary report illustrates productivity data that is summarized and arranged by employee so that the productivity and efficiency of employees picking items during a given work week can be determined at-a-glance. In this regard, the processor determines the total work hours, total picking hours planned, the total actual picking hours, the average efficiency (e.g., % Effective Planned vs. Actual), the total number of over allowed or under allowed hours, the total non-picking hours, the total number of line items, the total picking lines per hour, and the total lines per hour for each employee that worked during the week. The exemplary report shown in FIG. 26 illustrates this data for the week beginning on Feb. 1, 2009 and ending on Feb. 7, 2009. Additionally, the processor is configured to determine the weekly totals for all employees working during the week. In this regard, the overall productivity of a group of employees working during a given week can be determined at-a-glance.

It should be understood that each block or step of the flowchart shown in FIG. 14 and combination of blocks in the flowchart can be implemented by various techniques, such as hardware, firmware, or software in memory including one or more computer program instructions. For example, one or more of the procedures described above are embodied by computer program instructions. In particular, according to one embodiment, the computer program instructions that embody the procedures described above are stored by a memory device (e.g., data storage unit 86, memory 96) of the warehouse picking productivity device 150 and executed by a built-in processor (e.g., processor 84, 94) in the device 150 or device 91. As will be appreciated, any such computer program instructions are loaded onto a computer or other programmable apparatus (e.g., hardware such as, for example, device 150 or device 91) to produce a machine, such that the instructions which execute on the computer or other programmable apparatus (e.g., hardware) for implementing the functions specified in the flowcharts block(s) or step(s) (e.g., Steps 1400-1425). These computer program instructions are also stored in a computer-readable memory (e.g., data storage unit 86, memory 96) that can direct a computer or other programmable apparatus to function in a particular manner, such that the instructions stored in the computer-readable memory produce an article of manufacture including instruction means which implement the functions specified in the flowcharts block(s) or step(s). The computer program instructions configured to be loaded onto a computer or other programmable apparatus to cause a series of operational steps to be performed on the computer or other programmable apparatus to produce a computer-implemented process such that the instructions which execute on the computer or other programmable apparatus provide steps for implementing the functions that are carried out in the system.

The above described functions are carried out in many ways. For example, any suitable means for carrying out each of the functions described above are employed to carry out the invention. In one embodiment, all or a portion of the elements of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A computer program product for managing productivity associated with the retrieval of items, the computer program product comprising at least one computer-readable storage medium having computer-readable program code portions stored therein, the computer-readable program code portions comprising:
a first executable portion configured to generate a first time for traveling to one or more locations at which one or more items to be retrieved are located;
a second executable portion configured to generate a second time for retrieving the one or more items from the one or more locations;
a third executable portion configured to generate a third time for accessing one or more access points corresponding to each location, the third time being based on a respective height of each of the one or more access points; and
a fourth executable portion configured to add the first, second, and third times to generate a fourth time representing a target pick time for retrieving the one or more items.

2. The computer program product of claim 1, further comprising:
a fifth executable portion configured to generate a fifth time associated with a time for beginning one or more activities related to the retrieval of the one or more items; and
a sixth executable portion configured to generate a sixth time associated with a time for completing activities related to the retrieval of the one or more items,
wherein the fourth executable portion is further configured to add the fifth and sixth times to the first, second, and third times to generate the fourth time.

3. The computer program product of claim 1, wherein the second time generated by the second executable portion comprises a base amount of time expected to retrieve the one or more items and any additional amount of time expected for handling at least one of the one or more items.

4. The computer program product of claim 3, wherein the additional amount of time expected for handling at least one of the items is based on a weight of the item.

5. The computer program product of claim 1, wherein the first time is based in part on a shortest travel distance between each of the one or more locations.

6. The computer program product of claim 1, wherein the first time is based in part on a length of at least one aisle and an x, y coordinate of each of the one or more locations.

7. The computer program product of claim 1, wherein the second and third times are based in part on a quantity of the items to be retrieved and accessed, respectively.

8. The computer program product of claim 1, further comprising:
a fifth executable portion configured to determine an actual amount of time spent by one or more individuals retrieving the one or more items;
a sixth executable portion configured to compare the actual amount of time to the fourth time;
a seventh executable portion configured to identify the one or more individuals as being efficient in response to the actual amount of time being equal to or less than the fourth time; and
an eighth executable portion configured to identify the one or more individuals as being inefficient in response to the actual amount of time being greater than the fourth time.

9. An apparatus for managing productivity associated with the retrieval of items, wherein the apparatus comprises a memory and a computer processor configured to:
generate a first time for traveling to one or more locations in which one or more items to be retrieved are located;
generate a second time for retrieving the one or more items from the one of the locations;
generate a third time for accessing one or more access points corresponding to each location, the third time being based on a respective height of each of the one or more access points; and
add the first, second, and third times to generate a fourth time representing a target pick time for retrieving the one or more items.

10. The apparatus of claim 9, wherein the processor is further configured to:
generate a fifth time associated with a time for beginning one or more activities related to the retrieval of the items;
generate a sixth time associated with a time for completing activities related to the retrieval of the items; and
add the fifth and sixth times to the first, second, and third times to generate the fourth time.

11. The apparatus of claim 9, wherein the second time comprises a base amount of time expected to retrieve the one or more items and any additional amount of time expected for handling at least one of the one or more items.

12. The apparatus of claim 11, wherein the additional amount of time expected for handling at least one of the items is based on a weight of the item.

13. The apparatus of claim 9, wherein the first time is based in part on a shortest travel distance between each of the one or more locations.

14. The apparatus of claim 9, wherein the first time is based in part on a length of at least one aisle and an x, y coordinate of each of the one or more locations.

15. The apparatus of claim 9, wherein the second and third times are based in part on a quantity of the items to be retrieved and accessed, respectively.

16. The apparatus of claim 9, wherein the processor is further configured to:
determine an actual amount of time spent by one or more individuals retrieving the one or more items;
compare the actual amount of time to the fourth time;
identify the one or more individuals as efficient in response to the actual amount of time being equal to or less than the fourth time; and
identify the one or more individuals as inefficient in response to the actual amount of time being greater than the fourth time.

17. A method for managing productivity associated with the retrieval of items, comprising:
generating a first time for traveling to one or more locations in which one or more items are located;
generating a second time for retrieving the one or more items from the one or more locations;
generating a third time for accessing one or more access points corresponding to each location, the third time being based on a respective height of each of the one or more access points; and
adding, via a productivity computing device, the first, second, and third times to generate a fourth time representing a target pick time for retrieving the one or more items.

18. The method of claim 17, wherein the method further comprises the steps of:
generating a fifth time associated with a time for beginning one or more activities related to the retrieval of the one or more items, and
generating a sixth time associated with a time for completing activities related to the retrieval of the one or more items,
wherein the step of adding further comprises adding the fifth and sixth times to the first, second, and third times to generate the fourth time.

19. The method of claim 17, further comprising determining that the second time comprises a base amount of time expected to retrieve the one or more items and any additional amount of time expected for handling at least one of the one or more items.

20. The method of claim 19, wherein the additional amount of time expected for handling at least one of the items is based on a weight of the item.

21. The method of claim 17, wherein the first time is based in part on a shortest travel distance between each of the one or more locations.

22. The method of claim 17, wherein the first time is based in part on a length of at least one aisle and an x, y coordinate of each location.

23. The method of claim 19, wherein the second and third times are based in part on a quantity of the items to be retrieved and accessed, respectively.
